(19) United States
(12) Patent Application Publication
(10) Pub. No.: US 2026/0001314 A1
(43) Pub. Date: Jan. 1, 2026

(54) NON-TRANSITORY COMPUTER READABLE STORAGE MEDIUM STORING IMAGING CONTROL PROGRAM AND PRINTING SYSTEM

(71) Applicant: SEIKO EPSON CORPORATION, Tokyo (JP)

(72) Inventor: Eishin YOSHIKAWA, MATSUMOTO-SHI (JP)

(21) Appl. No.: 19/245,919

(22) Filed: Jun. 23, 2025

(30) Foreign Application Priority Data
Jun. 28, 2024 (JP) 2024-105256

(51) Int. Cl. B41F 33/00; G06T 5/73; G06T 5/92

(52) U.S. Cl. CPC B41F 33/0036; G06T 5/73; G06T 5/92

(57) ABSTRACT

The judgment function judges whether an imaging condition for causing the imaging section to execute imaging of an imaging target region including the test pattern is satisfied. The imaging control function acquires a captured image by causing the imaging section to execute imaging of the imaging target region with satisfaction of the imaging condition as a trigger. The imaging condition is a condition that at least one of the basic conditions is satisfied for at least the predetermined time, where the first condition is that the variation of the relative positional relationship between the imaging section and the medium is equal to or less than the reference variation, and the second condition is that the distortion amount indicating the distortion of the test pattern included in the frames repeatedly acquired from the imaging section is equal to or less than the reference distortion amount. The judgment function judges that the imaging condition is satisfied when at least the basic condition is continuously satisfied for the predetermined time or more.

The present application is based on, and claims priority from JP Application Serial Number 2024-105256, filed Jun. 28, 2024, the disclosure of which is hereby incorporated by reference herein in its entirety.

### BACKGROUND

### 1. Technical Field

The present disclosure relates to an imaging control program for imaging a medium having a test pattern for adjusting printing characteristics, and a printing system.

### 2. Related Art

A test pattern for adjusting printing characteristics of a printing device, such as an inkjet printer, is read by a scanner in the related art.

In JP-A-2006-121486, the disclosure discloses a print correction method for generating print correction data by capturing a print correction test pattern printed by a printer with a digital camera.

In the environment of the user, various problems may occur in order to appropriately obtain the imaging result of the test pattern.

For example, when a user holds a camera-equipped portable terminal such as a smartphone by hand to capture an image, camera shake may occur. Here, in many camera-equipped portable terminals, for convenience of processing a time lag occurs from when an imaging button is operated to when a captured image is acquired. Therefore, even if there is no camera shake at the time of operating the imaging button, due to camera shake occurring at the time of actual imaging, a captured image with camera shake is obtained.

Even in an imaging device having a small time lag as in a digital camera, when imaging is performed in a state where a user holds a medium having a test pattern by hand and holds it in front of imaging device, the medium may be distorted, for example, by sagging. Therefore, the medium is distorted at the time of imaging, and thus a captured image in which distortion occurs is obtained.

In either case, a highly reliable image pickup result of the test pattern cannot be obtained.

### SUMMARY

According to present disclosure, a non-transitory computer readable storage medium storing a program, that is an imaging control program for imaging a medium having a test pattern for adjusting printing characteristics of a printing device including a recording head, the imaging control program includes
causing a computer to execute a judgment function of determining whether an imaging condition for causing an imaging section to execute imaging of an imaging target region including the test pattern is satisfied and
with the satisfaction of the imaging condition as a trigger, causing the computer to execute an imaging control function of causing the imaging section to execute imaging of the imaging target region to acquire a captured image, wherein
the imaging condition is a condition that at least one basic condition is continuously satisfied for a predetermined time or more, the at least one basic condition being at least one of a first condition that a variation amount of a relative positional relationship between the imaging section and the medium is equal to or less than a reference variation or a second condition that a distortion amount indicating distortion of the test pattern included in a frame repeatedly acquired from the imaging section is equal to or less than a reference distortion amount and
the judgment function has
   when judging whether the first condition is satisfied, acquiring repeatedly the change amount and judging whether the first condition is satisfied based on the acquired change amount,
   when judging whether the second condition is satisfied, judging whether the second condition is satisfied based on a shape of the test pattern included in the frame, and
   when at least the basic condition is continuously satisfied for the predetermined time or more, judging that the imaging condition is satisfied.

A printing system according to present disclosure is the printing system that includes a printing device including a recording head and an information terminal that captures an image of a medium having a test pattern for adjusting a printing characteristic of the printing device, wherein
the information terminal includes
   an imaging section and
   a control section that has a memory for storing a captured image obtained from the imaging section and that causes the imaging section to execute imaging of an imaging target region including the test pattern,
the control section judges whether an imaging condition for causing the imaging section to perform imaging of the imaging target region is satisfied and, with the satisfaction of the imaging condition as a trigger, causes the imaging section to perform imaging of the imaging target region to acquire the captured image,
the imaging condition is a condition that at least one basic condition is continuously satisfied for a predetermined time or more, the at least one basic condition being at least one of a first condition that a variation amount of a relative positional relationship between the imaging section and the medium is equal to or less than a reference variation or a second condition that a distortion amount indicating distortion of the test pattern included in a frame repeatedly acquired from the imaging section is equal to or less than a reference distortion amount and
the control section executes
   when judging whether the first condition is satisfied, acquiring repeatedly the change amount and judging whether the first condition is satisfied based on the acquired change amount,
   when judging whether the second condition is satisfied, judging whether the second condition is satisfied based on a shape of the test pattern included in the frame, and
   when at least the basic condition is continuously satisfied for the predetermined time or more, judging that the imaging condition is satisfied.

### BRIEF DESCRIPTION OF THE DRAWINGS

FIG. 1 is a diagram schematically illustrating an example of a printing system.

FIG. 2 is a diagram schematically illustrating a configuration example of a printing system.

FIG. 3 is a diagram schematically illustrating an example of a medium having a test pattern.

FIG. 4 is a diagram schematically illustrating an operation example of the information terminal at the time of imaging.

FIG. 5 is a flowchart schematically showing an example of an imaging control process.

FIG. 6 is a diagram schematically illustrating an example of whether a first condition that a change amount of a relative positional relationship between an imaging section and a medium is equal to or less than a reference variation is satisfied.

FIG. 7 is a diagram schematically illustrating an example of whether a second condition that a distortion amount of a test pattern included in a frame is equal to or less than a reference distortion amount is satisfied.

FIG. 8 is a diagram schematically illustrating an example of whether a third condition that an imaging target region is included in an angle of view of an imaging section is satisfied.

FIG. 9 is a diagram schematically illustrating an example of whether a fourth condition that the imaging section is within a predetermined facing range with respect to the imaging target region is satisfied.

FIG. 10 is a diagram schematically illustrating an example of whether a fifth condition that a gap amount between the imaging section and the medium is equal to or less than a reference gap amount is satisfied.

FIG. 11A is a diagram schematically illustrating an example of whether a sixth condition that the brightness amount of the background color of the medium is equal to or greater than the reference brightness amount is satisfied.

FIG. 11B is a diagram schematically illustrating an example of whether a sixth condition that the brightness amount of the background color of the medium is equal to or greater than the reference brightness amount is satisfied.

FIG. 12 is a diagram schematically illustrating an example of a judgment criterion for an imaging condition.

FIG. 13 is a diagram schematically illustrating an example of adjustment of a printing characteristic.

FIG. 14 is a plan view schematically illustrating another example of the printing system.

FIG. 15 is a flowchart schematically illustrating an example of a judgment standby time determination process.

FIG. 16 is a flowchart schematically illustrating another example of the judgment standby time determination process.

FIG. 17 is a diagram schematically illustrating a processing example of changing a criterion for condition determination in the middle of a judgment standby time.

### DESCRIPTION OF EMBODIMENTS

Hereinafter, embodiments of the present disclosure will be described. Of course, the following embodiments merely exemplify the present disclosure, and not all features shown in the embodiments are necessarily essential to the solutions in the present disclosure.

### 1. OUTLINE OF ASPECTS INCLUDED IN THE PRESENT DISCLOSURE

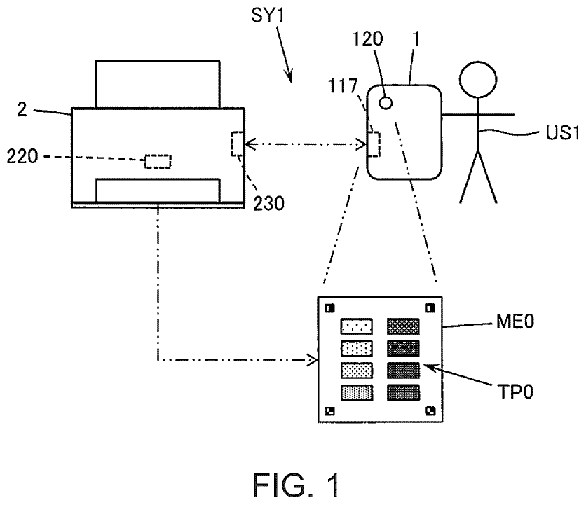

First, an overview of aspects included in the present disclosure will be described with reference to examples shown in FIGS. 1 to 17. Drawings of the present disclosure are diagrams that schematically show examples. The enlargement ratios in the directions illustrated in these drawings may differ, and the respective alignments may not match. Of course, each element of the present aspect is not limited to a specific example indicated by a reference numeral. In the “Outline of aspects included in the present disclosure”, terms in parentheses mean a supplementary explanation of the immediately preceding term.

### First Aspect

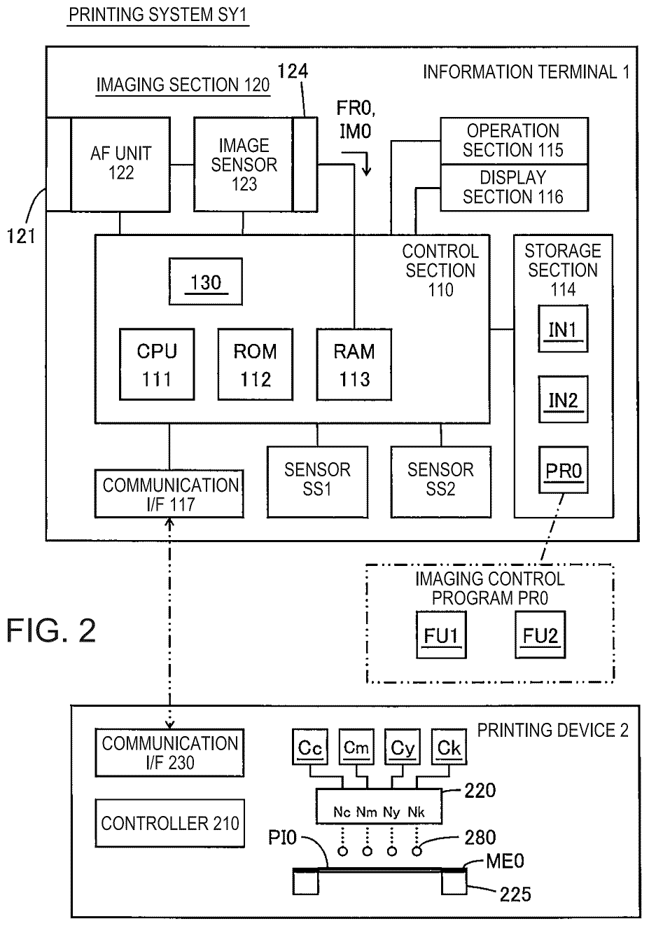

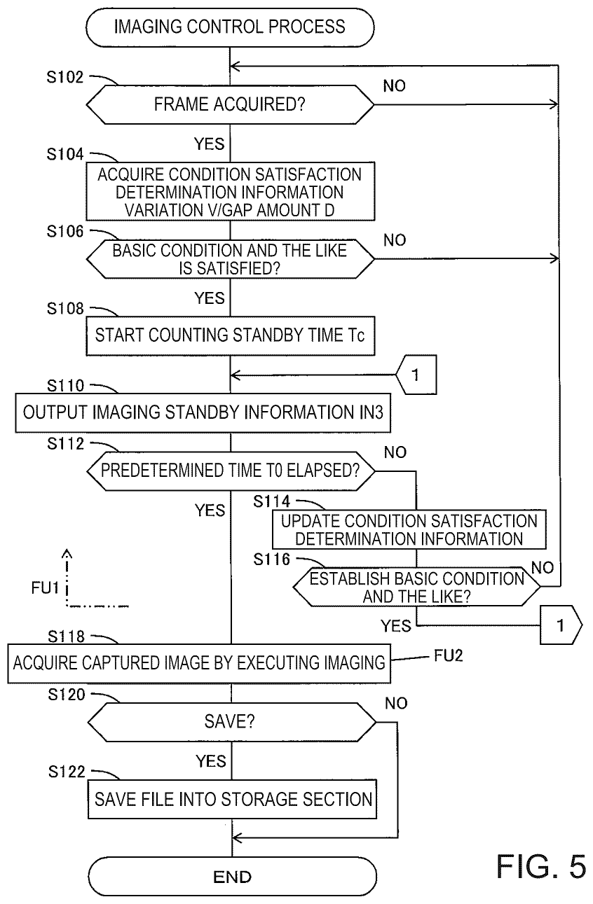

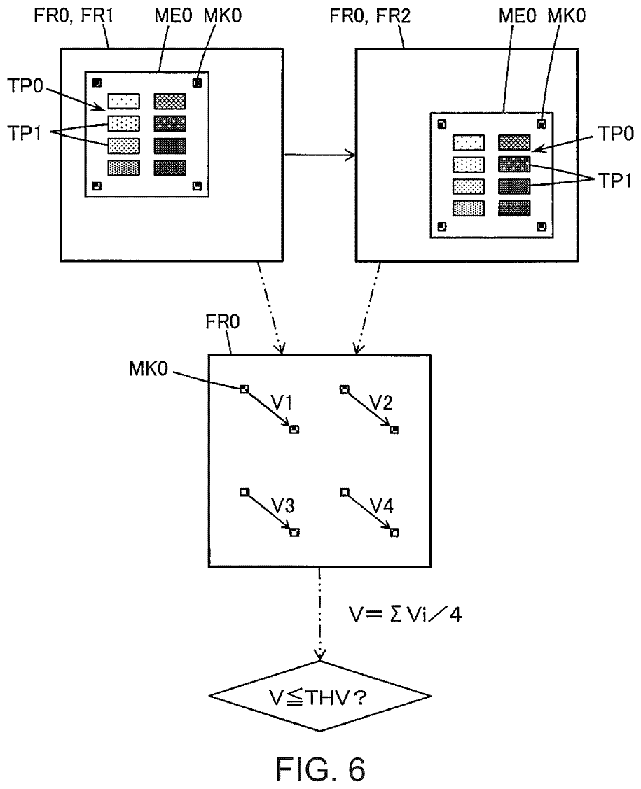

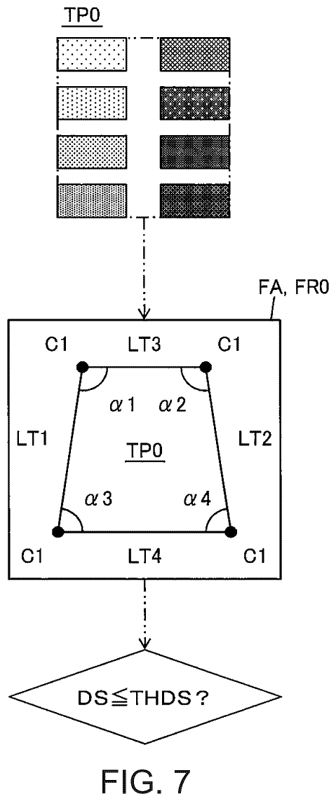

As illustrated in FIGS. 2 and 5, an imaging control program PRO according to an aspect is an imaging control program PRO for imaging a medium ME0 having a test pattern TP0 for adjusting printing characteristics of a printing device 2 including a recording head 220, and causes a computer (for example, an information terminal 1) to implement a judgment function FU1 and an imaging control function FU2. The judgment function FU1 judges whether an imaging condition for causing an imaging section 120 to image the imaging target region AR0 including the test pattern TP0 is satisfied. The imaging control function FU2 acquires the captured image IMO by causing the imaging section 120 to capture an image of the imaging target region AR0 with satisfaction of the imaging condition as a trigger. An imaging condition is a condition in which least one basic condition is continuously satisfied for a predetermined time T0 or more. The basic conditions are a first condition (for example, see FIG. 6) in which a variation V of a relative positional relationship between the imaging section 120 and the medium ME0 is equal to or less than a reference variation (for example, a threshold THV) and a second condition (for example, see FIG. 7) in which a distortion amount DS indicating distortion of the test pattern TP0 included in the frame FR0 repeatedly acquired from the imaging section 120 is equal to or less than a reference distortion amount (for example, a reference value THDS). When judging whether the first condition is satisfied, the judgment function FU1 repeatedly acquires the variation V and judges whether the first condition is satisfied based on the acquired variation V. When judging whether the second condition is satisfied, the judgment function FU1 judges whether the second condition is satisfied based on the shape of the test pattern TP0 included in the frame FR0. The judgment function FU1 judges that the imaging condition is satisfied when at least the basic condition is continuously satisfied for the predetermined time T0 or longer.

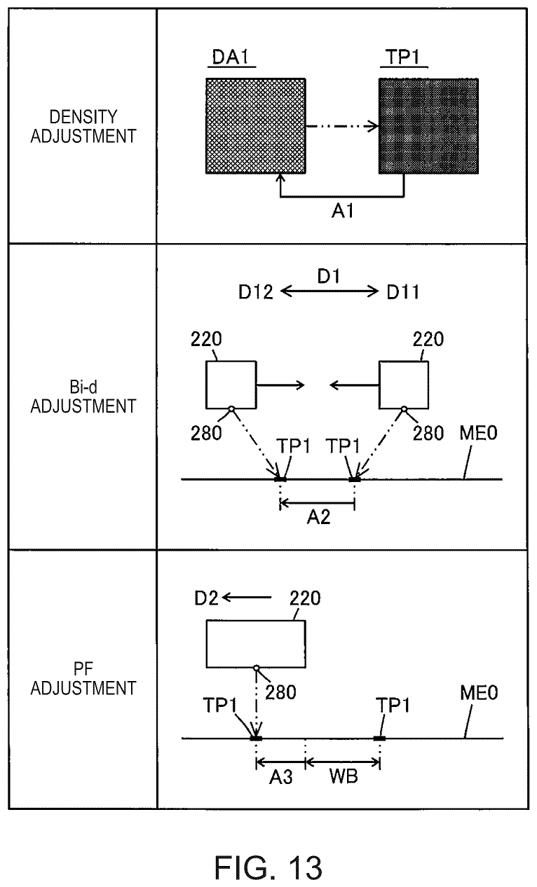

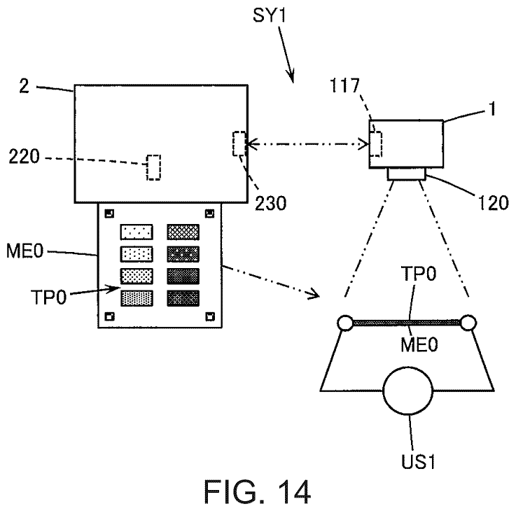

As illustrated in FIG. 1, when the information terminal 1 and the printing device 2 are configured separately, and the information terminal 1 is used to capture the test pattern TP0, there is a possibility that a captured image IMO in which camera shake occurs is obtained. In particular, in a case where there is a time-lag from when the user US1 directs the imaging section 120 toward the test pattern TP0 to take a posture for imaging until the captured image IMO is acquired, even if there is no camera shake at first, camera shake may occur at the time of actual imaging. As shown in FIG. 14, when the user US1 holds the medium ME0 having the test pattern TP0 by hand and holds it in front of the imaging device, the test pattern TP0 may be significantly distorted. When the captured image IMO is blurred or the test pattern TP0 is significantly distorted, the position and color of the test pattern TP0 are not correctly acquired, and a highly reliable imaging result of the test pattern TP0 cannot be acquired. It can also be said that highly reliable adjustment values (for example, the adjustment values A1 to A3 illustrated in FIG. 13) cannot be obtained from the test pattern TP0.

In the first aspect, imaging is performed with a basic condition being at least satisfied continuously for the predetermined time T0 or more as a trigger. As described above, the basic condition is at least one of the first condition that the variation V of the relative positional relationship between the imaging section 120 and the medium ME0 is equal to or less than the reference variation (THV) and the second condition that the distortion amount DS indicating the distortion of the test pattern TP0 included in the frame FR0 repeatedly acquired from the imaging section 120 is equal to or less than the reference distortion amount (THDS). When the first condition is continuously satisfied for the predetermined time T0 or more, even if there is a time lag from the start of the imaging posture to the actual acquisition of the captured image IMO of the test pattern TP0, due to the small picture blur state continuing, the small picture blur is likely to remain small even after the time lag has elapsed. Since the picture blur at the time of actual imaging is less likely to occur, an appropriate test pattern captured image can be used for adjusting the printing characteristics. When image capture is triggered by the second condition being at least satisfied for the predetermined time T0 or longer, the possibility that the distortion of the test pattern TP0 is small at the time of image capture is high because the state where the distortion of the medium ME0 is small continues. By suppressing the distortion of the test pattern TP0 at the time of imaging, it is possible to use an appropriate test pattern captured image for adjusting the printing characteristics.

As described above, the above aspect can provide an imaging control program capable of acquiring an imaging result of a test pattern with high reliability.

The aspects described above include various examples.

Examples of the printing characteristics include the density of a printed image, the landing position of a liquid droplet, the transport amount of a medium, the liquid droplet ejection state of each nozzle, and the like.

Examples of the test pattern include a density pattern for adjusting the density of a print image, a Bi-d adjustment pattern for performing Bi-d adjustment (bidirectional adjustment) for matching the landing positions of liquid droplets in the forward pass and the return pass, a transport amount adjustment pattern for adjusting the transport amount of a medium on which a print image is formed, a nozzle check pattern indicating the liquid droplet ejection state of each nozzle of the recording head, and the like.

Examples of the imaging target region includes the entire medium, a region partitioned by a plurality of position detection patterns, and the like.

The acquisition of the captured image may involve storing the captured image obtained from the imaging section in the memory or may involve controlling the direct memory access (DMA) controller to store the captured image in the memory. The storing in the memory includes storing in random access memory (RAM), storing in a non-volatile memory, and the like.

The frame means an image represented by a signal output from the imaging section for each frame period.

Examples of the change amount in the relative positional relationship between the imaging section and the medium include the movement amount of the medium between frames, the speed detected by a speed sensor, the acceleration detected by an acceleration sensor, and the like.

In this application, “first”, “second”, and so on are terms for identifying components included in a plurality of components having a similar point, and do not mean an order.

Of course, the above mentioned additional remarks also apply to the following aspects.

### Second Aspect

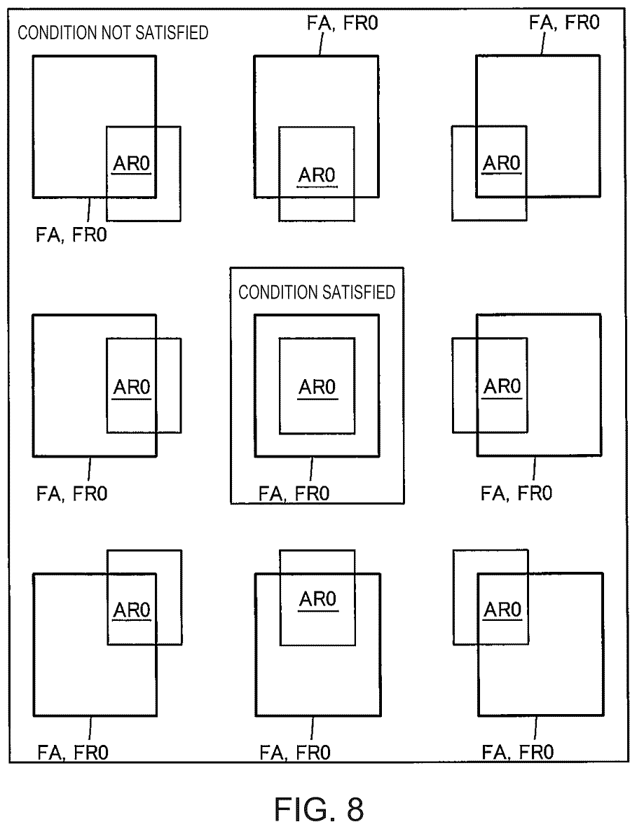

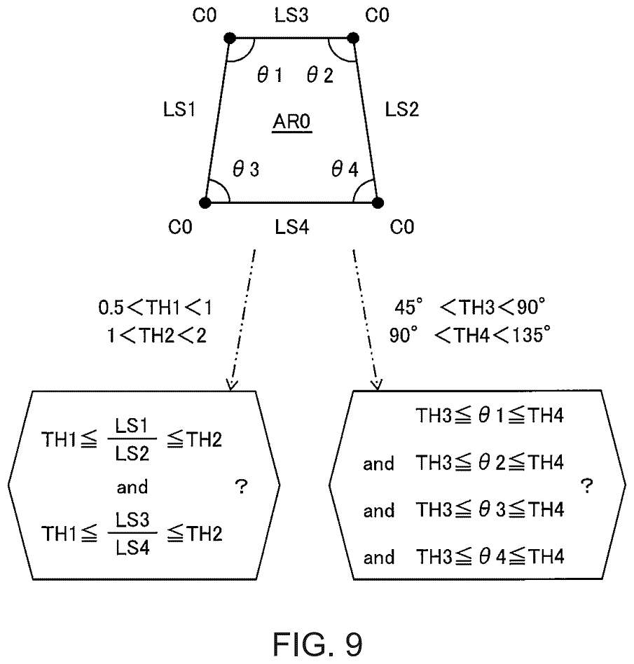

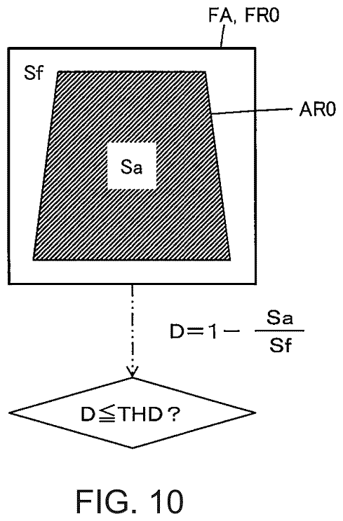

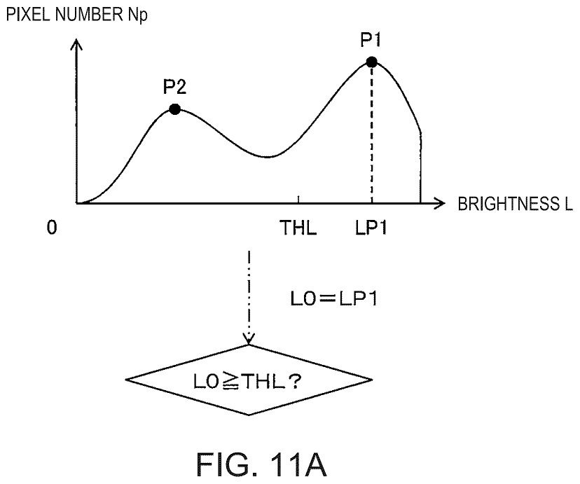

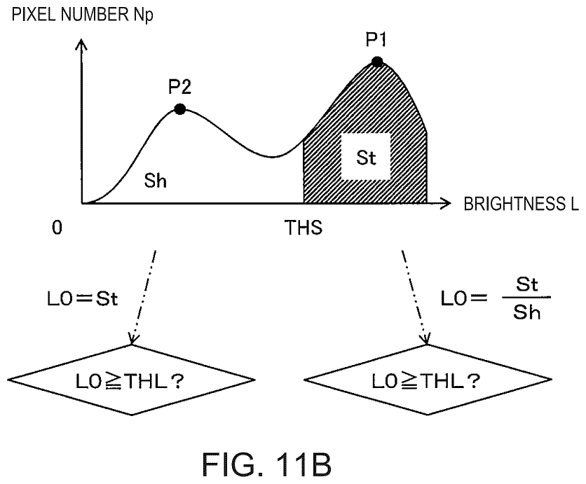

The imaging condition may be a condition that the basic condition and the additional condition are continuously satisfied for the predetermined time T0 or more. The additional condition may be at least one of a third condition (for example, see FIG. 8) that the imaging target region AR0 is included in the angle of view FA of the imaging section 120, a fourth condition (for example, see FIG. 9) that the imaging section 120 is within a predetermined facing range with respect to the imaging target region AR0, a fifth condition (for example, see FIG. 10) that a gap amount D corresponding to a gap between the imaging section 120 and the medium ME0 is equal to or less than a reference gap amount (for example, the threshold THD), and a sixth condition (for example, see FIG. 11) that a brightness amount L0 indicating the brightness L of the background color of the medium ME0 is equal to or greater than a reference brightness amount (for example, a reference value THL). The angle of view means an imaging range. When judging whether the third condition is satisfied, the judgment function FU1 may judge whether the third condition is satisfied based on the frame FR0. When judging whether the fourth condition is satisfied, the judgment function FU1 may judge whether the fourth condition is satisfied based on the shape of the imaging target region AR0 included in the frame FR0. When judging whether the fifth condition is satisfied, the judgment function FU1 may repeatedly detect the gap amount D and judge whether the fifth condition is satisfied based on the detected gap amount D. When judging whether the sixth condition is satisfied, the judgment function FU1 may acquire the brightness amount L0 based on the frame FR0, and judge whether the sixth condition is satisfied based on the acquired brightness amount L0. The judgment function FU1 may judge that the imaging condition is satisfied when the basic condition and the additional condition are continuously satisfied for the predetermined time T0 or more.

In the above aspect, the imaging is performed with the fact that the basic condition and the additional condition are continuously satisfied for the predetermined time T0 or more as a trigger.

For example, when the imaging range is an unintended range, the position and color of the test pattern TP0 are not correctly acquired. By this, the test pattern TP0 does not function correctly. When the imaging is performed when the third condition is satisfied, the captured image IMO of an appropriate imaging range is obtained, and a more appropriate test pattern captured image can be used for adjusting the printing characteristics.

When the imaging section 120 is not within the facing range with respect to the test pattern TP0, the resolutions are different between the side close to the imaging section 120 and the side far from the imaging section 120 in the test pattern TP0, and the obtained adjustment value may be different between the side close to the imaging section 120 and the side far from the imaging section 120. When the fourth condition is satisfied, the image capture is performed, the change in the adjustment value as described above is suppressed, and a more appropriate test pattern captured image can be used for the adjustment of the printing characteristics.

If the imaging section 120 is too far from the medium ME0, the resolution of the imaged test pattern TP0 become low, and errors in the adjustment values become large. When imaging is performed when the fifth condition is satisfied, the error of the adjustment value described above is suppressed, and a more appropriate test pattern captured image can be used for the adjustment of the printing characteristics.

For example, when the captured image IMO is dark due to the influence of a shadow or the like, the density of the captured test pattern TP0 becomes high, and the color or the like of the test pattern TP0 is not correctly acquired. When the imaging is performed when the sixth condition is satisfied, the color of the test pattern TP0 and the like are correctly acquired, and a more appropriate test pattern captured image can be used for adjusting the printing characteristics.

As described above, the above aspect can provide an imaging control program capable of acquiring an imaging result of a test pattern with higher reliability.

### Third Aspect

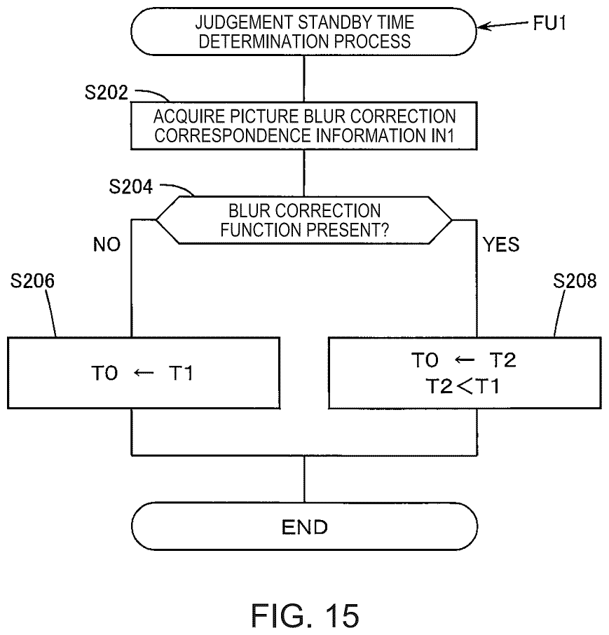

As illustrated in FIG. 15 and the like, the judgment function FU1 may change the predetermined time T0. The judgment function FU1 may acquire blur correction function correspondence information IN1 indicating whether a picture blur correction function for correcting a picture blur of the captured image IMO is provided, and the predetermined time T0 may be set shorter in the case where the blur correction function is provided than in the case where the blur correction function is not provided, based on the picture blur correction correspondence information IN1.

In a case where the imaging device has a blur correction function, even if a picture blur occurs due to the fact that the time for which at least the basic condition is satisfied is relatively short, the picture blur is corrected. By this, even if the predetermined time T0 is shortened, it is possible to acquire an imaging result of the test pattern TP0 with high reliability. Therefore, the above aspect can shorten the standby time when the imaging device has the blur correction function, and can improve usability.

Here, the judgment function FU1 may acquire the picture blur correction correspondence information IN1 from a control section 110 that controls the imaging section 120, or may receive a selection operation of whether there are blur correction functions from the user US1 via an operation section 115 and acquire the picture blur correction correspondence information IN1 according to the selection operation. Further, the judgment function FU1 may receive a selection operation of whether to set the predetermined time T0 to “short time” or “long time” from the user US1 via the operation section 115, and thereby acquire the picture blur correction correspondence information IN1 according to the selection operation. In this case, the selection operation of “short time” means a selection operation with a blur correction function, and the selection operation of “long time” means a selection operation without picture blur correction.

### Fourth Aspect

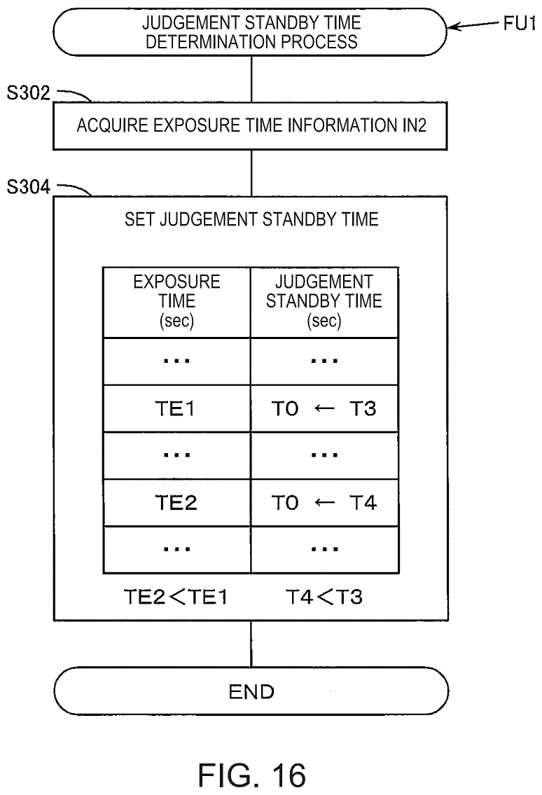

As shown in FIG. 16, the exposure time (also referred to as shutter speed) applied to the imaging section 120 may be changeable. The judgment function FU1 may change the predetermined time T0. The judgment function FU1 may acquire exposure time information IN2 indicating the exposure time from the control section 110 that controls the imaging section 120, and when the exposure time is a second time (for example, the exposure time TE2) shorter than a first time (for example, the exposure time TE1) based on the exposure time information IN2, the predetermined time T0 may be shorter than when the exposure time is the first time (TE1).

In a case where the imaging device can change the exposure time of the imaging section 120, if the exposure time is relatively short, even if a picture blur occurs due to the fact that the time for which at least the basic condition is satisfied is relatively short, the picture blur has little influence on the captured image IMO. By this, it possible to acquire a highly reliable imaging result of the test pattern TP0. Therefore, in the above aspect, the standby time can be shortened when the imaging device can change the exposure time of the imaging section 120, and the usability can be improved.

### Fifth Aspect

As illustrated in FIG. 5, the judgment function FU1 may cause an output section (for example, a display section 116) to output information (for example, imaging standby information IN3) indicating that at least the basic condition is continuously satisfied.

In this case, the user can grasp the information (IN3) indicating that at least the basic condition is continuously satisfied, and thus it is possible to improve usability.

Here, the output section may be a display section that displays information or a voice output section that outputs information by voice.

### Sixth Aspect

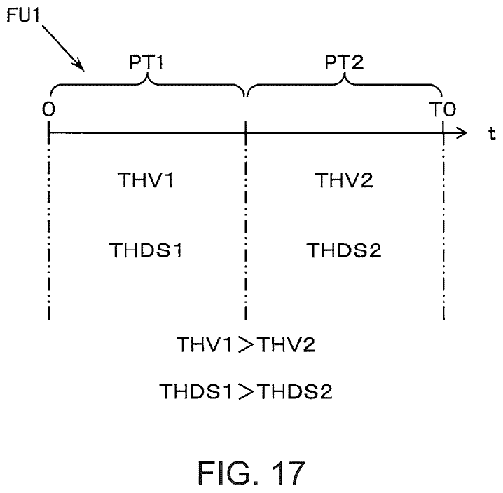

As illustrated in FIG. 17, the predetermined time T0 may include a first period PT1 and a second period PT2 after the first period PT1. When judging whether the first condition is satisfied, the judgment function FU1 may set the reference variation (THV) applied to the second period PT2 to be smaller than the reference variation amount (THV) applied to the first period PT1. When judging whether the second condition is satisfied, the judgment function FU1 may set the reference distortion amount (THDS) applied to the second period PT2 to be smaller than the reference distortion amount (THDS) applied to the first period PT1.

During the time of continuously monitoring that the basic condition is at least t satisfied, when the reference variation amount (THV) and the reference distortion amount (THDS) are relatively small in the relatively later second period PT2, even if the reference variation amount (THV) and the reference distortion amount (THDS) are relatively large in the relatively previous first period PT1, a highly reliable imaging result of the test pattern TP0 can be obtained. Therefore, the above aspect can shorten the time required for imaging.

Here, the predetermined time may include a third period after the second period, and the like. The judgment function FU1 may set the criterion applied to the third period smaller than the criterion applied to the second period.

### Seventh Aspect

As shown in FIGS. 1, 2, and 14, a printing system SY1 according to an aspect is a printing system SY1 including the printing device 2 having the recording head 220 and the information terminal 1 that images a medium ME0 having a test pattern TP0 for adjusting printing characteristics of the printing device 2. The information terminal 1 includes the imaging section 120, a memory (for example, a RAM 113) for storing a captured image IMO obtained from the imaging section 120, and the control section 110 that causes the imaging section 120 to image an imaging target region AR0 including the test pattern TP0. The control section 110 judges whether an imaging condition for causing the imaging section 120 to execute imaging of the imaging target region AR0 is satisfied, and acquires the captured image IMO by causing the imaging section 120 to execute imaging of the imaging target region AR0 with the satisfaction of the imaging condition as a trigger. The imaging condition is a condition that at least one of the basic conditions is satisfied for a predetermined time T0 or more. The basic conditions include a first condition that the variation V in the relative positional relationship between the imaging section 120 and the medium ME0 is less than or equal to a reference variation (THV), and a second condition that the distortion amount DS that indicates the distortion of the test pattern TP0 included in the frame FR0 repeatedly acquired from the imaging section 120 is equal to or less than a reference distortion amount (THDS). When judging whether the first condition is satisfied, the control section 110 repeatedly acquires the variation V and judges whether the first condition is satisfied based on the acquired the variation V. When judging whether the second condition is satisfied, the control section 110 judges whether the second condition is satisfied based on the shape of the test pattern TP0 included in the frame FR0. The control section 110 judges that the imaging condition is satisfied when at least the basic condition is continuously satisfied for the predetermined time T0 or more.

The above aspect can provide a printing system capable of acquiring an imaging result of a test pattern with high reliability.

Furthermore, the aspect described above can be applied to a computer-readable non-transitory medium in which the imaging control program described above is recorded, the information terminal described above, a control method of the information terminal, a printing method performed by the printing system described above, a control program of the printing system described above, a computer-readable non-transitory medium in which the control program is recorded, and the like. Any of the foregoing devices may be comprised of a plurality of distributed portions.

### 2. SPECIFIC EXAMPLE OF IMAGING CONTROL PROGRAM

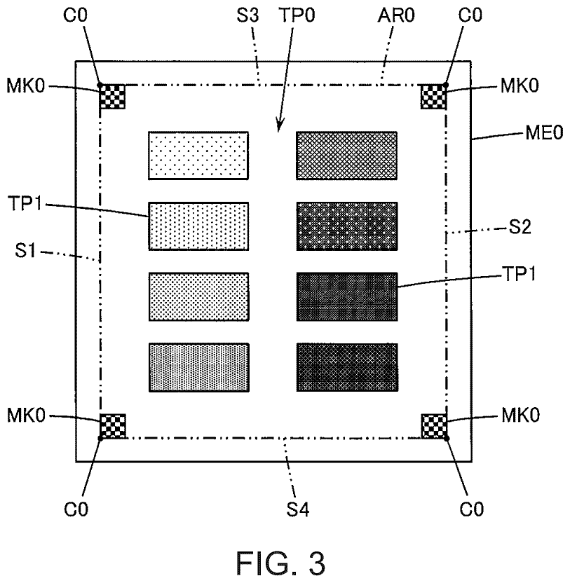

FIGS. 1 and 14 schematically illustrate a printing system SY1 including the information terminal 1 and the printing device 2. FIG. 2 schematically illustrates the configuration of the printing system SY1. FIG. 3 schematically illustrates a medium ME0 having a test pattern TP0.

Examples of the information terminal 1 (shown in FIG. 1) include a mobile phone such as a smartphone, a tablet terminal, and the like. The information terminal 1 may be configured as a plurality of devices that can communicate with each other, or as a stationary type device with a position-changeable imaging section coupled to it. The information terminal 1 may be a digital camera or the like as shown in a plan view of FIG. 14. The information terminal 1 illustrated in FIG. 14 is fixed so as not to move, and captures an image of the medium ME0 held in the user US1. The printing device 2 is assumed to be an inkjet printer including the recording head 220 capable of ejecting droplets 280. Of course, the printing device 2 may be a thermal printer (including a thermal transfer printer) provided with a thermal head as a recording head, an electrophotographic printer (for example, a laser printer) including a recording head that causes toner to adhere to the medium ME0, a three dimensional printer, or the like. The printing device 2 may be configured as the plurality of devices that can communicate with each other. The printing device 2 can form a print image PIO including a test pattern TP0 for adjusting the printing characteristics of the printing device 2 on the medium ME0.

In the printing system SY1 (shown in FIG. 1), the user US1 can adjust the printing characteristics of the printing device 2 by imaging the test pattern TP0 with the information terminal 1 including the imaging section 120. When the user US1 captures an image of the test pattern TP0 while holding the information terminal 1 by hand, there is a possibility that camera shake occurs, a part of the test pattern TP0 protrudes from an angle of view, that is, an imaging range of the imaging section 120, the test pattern TP0 is inclined, the test pattern TP0 is too far from the imaging section 120, or an imaging circumstance is too dark. In particular, in many camera-equipped portable terminals such as smartphones and tablet terminals, for convenience of processing a time lag occurs from when the imaging button is operated to when the captured image IMO is acquired. Therefore, even if there is no camera shake at the time of operating the imaging button, there is a case where camera shake occurs at the time of actual imaging, and in this case, the captured image IMO in which camera shake occurred is obtained. The adjustment values A1 to A3 (see FIG. 13) with high reliability cannot be obtained from the test pattern TP0 included in the captured image IMO in which camera shake occurred.

As illustrated in FIG. 14, when the information terminal 1 is an imaging device such as a digital camera, the time lag described above is small. However, even in the case of an imaging device with a small time-lag, when imaging is performed in a state where the user US1 holds the medium ME0 with by hand and holds it in front of the imaging device, the medium ME0 may be distorted, such as by sagging. Since the shape of the medium ME0 may change from moment to moment, the medium ME0 may be distorted at the time of imaging, and in this case, a distorted captured image IMO is obtained. The adjustment values A1 to A3 with high reliability (see FIG. 13) cannot be obtained from the test pattern TP0 included in the distorted captured image IMO.

Therefore, the imaging control program PRO (shown in FIG. 2) causes the imaging section 120 to automatically execute imaging that is triggered by satisfaction of an imaging condition meaning that imaging is possible for a certain period of time, thereby causing the information terminal 1 to realize imaging of an appropriate test pattern TP0. For example, when a state in which no camera shake occurs continues for a certain period of time, there is a high possibility that no camera shake occurred even at the time point when the time lag has elapsed. When the state in which the distortion of the test pattern TP0 does not occur continues for a certain period of time, there is a high possibility that the distortion of the test pattern TP0 did not occur at the time of imaging. It can be said that the information terminal 1 that executes the imaging control program PRO realizes an automatic shutter system.

A communication interface (I/F) 117 of the information terminal 1 can communicate with a communication I/F 230 of the printing device 2. The information terminal 1 can transmit the adjustment values and the like of the printing characteristics to the printing device 2 via the communication I/Fs 117, 230. Upon receiving the adjustment value, the printing device 2 stores the adjustment value and adjusts the printing characteristics based on the adjustment value. The communication I/Fs 117, 230 may be wireless communications conforming to the standard of a wireless local area network (LAN), wired communications, or network communications such as the Internet.

The information terminal 1 illustrated in FIG. 2 includes the control section 110, a storage section 114, the operation section 115, the display section 116, the communication I/F 117, and the imaging section 120. The information terminal 1 may include a sensor SS1 and a sensor SS2 coupled with the control section 110. The control section 110 includes a central processing unit (CPU) 111 as processor, a read-only memory (ROM) 112, and the random access memory (RAM) 113. The RAM 113 is an example of a memory for storing the captured image IMO obtained from the imaging section 120. The control section 110 may include an exposure control section 130 that controls exposure of the imaging section 120. Some information terminals 1 are configured to increase the exposure time and release the shutter in order to capture a low-light scene such as a starry sky with high image quality. Details of the exposure control section 130 will be described later.

The storage section 114 stores an operating system (OS), an application program, blur correction correspondence information IN1 indicating whether the imaging section 120 includes a picture blur correction section 124, exposure time information IN2 indicating an exposure time, and the like. When the OS receives a command to execute imaging from the application program, the OS causes the information terminal 1 to implement a function of causing the imaging section 120 to execute imaging. The time lag can be said to be a time lag from the command for the OS to execute imaging to the acquisition of the captured image IMO. The application program includes an imaging control program PRO for imaging a medium ME0 having a test pattern TP0. The picture blur correction correspondence information IN1 indicates whether there is a picture blur correction function of correcting a picture blur of the captured image IMO. As the storage section 114, a non-volatile semiconductor memory such as flash memory can be used. The storage section 114 may be removably attached to the main body of the information terminal 1. The display section 116 displays a screen corresponding to the display information based on the display information. A liquid crystal display panel or the like can be used for the display section 116. As the operation section 115, a touch panel attached to the surface of the display section 116, a hard key, or the like can be used. The display section 116 is an example of an output section.

The imaging control program PRO causes the information terminal 1 to implement the judgment function FU1 and the imaging control function FU2. The CPU 111 reads information stored in the storage section 114 to the RAM 113 as appropriate and performs various processes by executing the read program. The CPU 111 executes the imaging control program PRO read out to the RAM 113, thereby performing processes corresponding to the above-described functions (FU1, FU2). The information terminal 1 that executes the imaging control program PRO performs a judgment process corresponding to the judgment function FU1 and an imaging control process corresponding to the imaging control function FU2. A computer-readable medium storing the imaging control program PRO, which enables the aforementioned functions (FU1, FU2) to be realized by a computer, is not limited to the storage section 114 and may also be an external storage medium of the information terminal 1.

The imaging section 120 includes a lens 121, an autofocus (AF) unit 122, an image sensor 123, and the like. The image sensor 123 converts an image of light incident via the lens 121 and the AF unit 122 into an electric signal. In this specific example, the image sensor 123 outputs digital data corresponding to an electric signal of each light receiving element. The digital data is stored in the RAM 113 as the frame FR0 or the captured image IMO. As the image sensor 123, a complementary metal-oxide semiconductor (CMOS) image sensor, a charge coupled devices (CCD) image sensor, or the like can be used.

The imaging section 120 may be equipped with a known picture blur correction section 124 to correct the picture blur of the captured image IMO. The picture blur correction section 124 may perform electronic picture blur correction for controlling an output range of the image sensor 123, may perform optical type picture blur correction for controlling movement of a correction lens or the like, or may perform image sensor moving blur correction for controlling movement of the image sensor 123. The picture blur correction section 124 detects the blur of the information terminal 1 by a picture blur sensor such as an acceleration sensor or an angular velocity sensor, and corrects the picture blur of the captured image IMO by controlling the range of outputs of the image sensor 123 or controlling the motion of a correction lens or the like in accordance with the detection result. The application program can cause the information terminal 1 to acquire the picture blur correction correspondence information IN1 from the OS by requesting the OS to output the picture blur correction correspondence information IN1.

The exposure control section 130 can change the exposure time to be applied to the imaging section 120. The exposure time is also referred to as a shutter speed, means a time for which the image sensor 123 is irradiated with light, and is represented by such as, 1 sec, ½ sec, ¼ sec, ⅛ sec, 1/15 sec, and so on. The shutter for changing the exposure time may be an electronic shutter or a mechanical shutter. In a case where the exposure control section 130 includes an electronic shutter, the exposure control section 130 controls each light receiving element of the image sensor 123 so that each light receiving element performs photoelectric conversion for a set exposure time. Since the image sensor 123 includes a large number of light receiving elements, it takes time to perform a process of generating the captured image IMO, and a time-lag occurs from the start of the imaging process to the generation of the captured image IMO. When the exposure control section 130 includes a mechanical shutter, the exposure control section 130 controls the movement of the shutter so that light is applied to the image sensor 123 for a set exposure time. The application program can cause the information terminal 1 to acquire the exposure time information IN2 from the OS by requesting the Os to output the exposure time information IN2. The sensors SS1 and SS2 can be used to judge whether the imaging condition is satisfied. For example, the sensor SS1 may be a speed sensor that measures the movement speed of the imaging section 120 or may be an acceleration sensor that measures the acceleration of the imaging section 120. In this case, it is possible to detect the magnitude of the blur of the captured image IMO based on the measurement value by the sensor SS1. The sensor SS2 may be a distance-measuring sensor that measures the distances from the imaging section 120 to the medium ME0. In this case, it is possible to detect the distances from the imaging section 120 to the medium ME0 based on the measured values by the sensor SS2.

The printing device 2 ejects cyan (C) ink, magenta (M) ink, yellow (Y) ink, and black (K) ink as color materials from the recording head 220 as droplets 280 to form the print image PIO corresponding to the print data. The recording head 220 includes a plurality of nozzles Nc capable of ejecting C ink droplets onto the medium ME0, a plurality of nozzles Nm capable of ejecting M ink droplets onto the medium ME0, a plurality of nozzles Ny capable of ejecting Y ink droplets onto the medium ME0, and a plurality of nozzles Nk capable of ejecting K ink droplets onto the medium ME0. The recording head 220 is supplied with C, M, Y, and K inks from ink cartridges Cc, Cm, Cy, and Ck, respectively. The recording head 220 ejects the droplets 280 of C, M, Y, and K from the nozzles Nc, Nm, Ny, and Nk, respectively, according to the control of a controller 210. When the droplets 280 land on the medium ME0, an ink dot is formed on the medium ME0. The printing device 2 includes a drive section that changes the relative positional relationship between the recording head 220 and the medium ME0 according to the control of the controller 210, for example, a transport section 225 that transports the medium ME0 in a predetermined transport direction. As a result, printed matter with a pattern of ink dots as the print image PIO on the medium ME0 is obtained. The material of the medium ME0 is not particularly limited and may be paper, fabric, resin, metal, or the like. The shape of medium ME0 may be a cut two-dimensional shape, a rolled like shape, or a three-dimensional shape.

The medium ME0 (shown in FIG. 3) has a test pattern TP0 including a plurality of individual patterns TP1, and a plurality of position detection patterns MK0. The test pattern TP0 may be a density pattern, a Bi-d adjustment pattern, a transport amount adjustment pattern, a nozzle check pattern, or the like. Each position detection pattern MK0 is arranged at a corner C0 of a rectangle including the test pattern TP0 on the medium ME0. When the position detection patterns MK0 are arranged at the four corners of the rectangle, the imaging target region AR0 including the test pattern TP0 is a rectangular region having the position detection patterns MK0 as the corners C0 on the medium ME0. In FIG. 3, a rectangular imaging target region AR0 with the vertical sides S1 and S2 and the horizontal sides S3 and S4 is indicated by two-dot chain line. As the position detection pattern MK0, a square ArUco marker with a specific geometric feature, a triangular pattern, or the like can be used.

When the position detection pattern MK0 is not present on the medium ME0, the medium ME0 itself becomes the imaging target region AR0. In this case, the medium ME0 is preferably cut as cut sheets and preferably has a rectangular shape, although this is not a limitation.

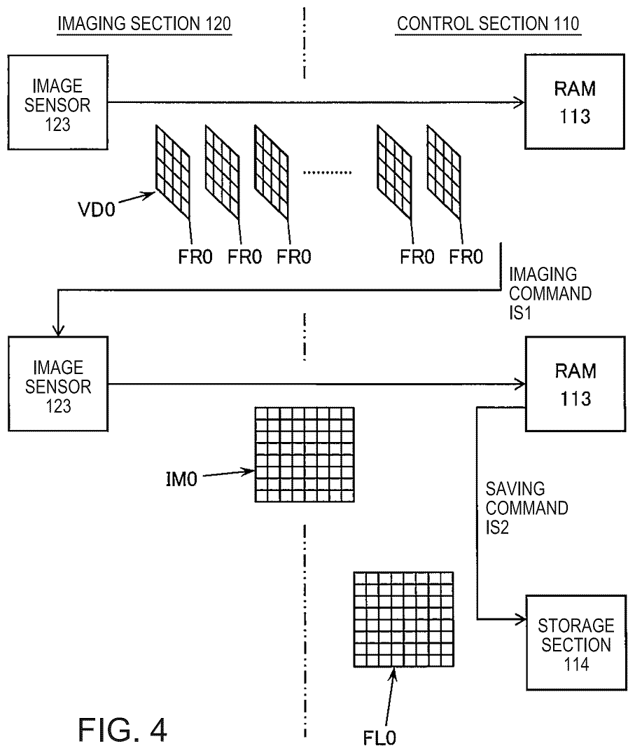

Next, an operation example of the information terminal 1 at the time of imaging will be described with reference to FIG. 4. In general, imaging is triggered by an operation on a shutter button included in the operation section 115.

The frame FR0 constituting a video VD0 is transferred from the image sensor 123 of the imaging section 120 to the RAM 113 of the control section 110 for each frame period. At this time, the CPU 111 may store the frame FR0 in the RAM 113, or a DMA controller (not shown) may store the frame FR0 in the RAM 113. Each frame FR0 represents a still image for each frame period but may have a difference from the previous frame as information. Due to the processing capability of the information terminal 1, each frame FR0 has a lower resolution than the captured image IMO. It can also be said that the frame FR0 has a smaller number of pixels than the captured image IMO. The control section 110 controls the AF unit 122 and the like based on the frame FR0 group. The control section 110 may cause the display section 116 to display each frame FR0.

When the user US1 performs an operation of pressing or touching the shutter button, the operation section 115 receives the operation, and the operation section 115 notifies the control section 110 that the shutter button has been operated. Then, the control section 110 commands an imaging instruction IS1 to the imaging section 120 to cause the imaging section 120 to execute imaging. The captured image IMO generated by this imaging has a resolution higher than that of frame FR0 and is stored in the RAM 113. Here, the CPU 111 may perform the process of storing the captured image IMO in the RAM 113, or the DMA controller (not illustrated) may perform the process of storing the captured image IMO in the RAM 113.

When the user US1 performs an operation of saving the captured image IMO, the operation section 115 receives the operation, and the operation section 115 notifies the control section 110 of a saving command IS2. Then, the control section 110 stores the captured image IMO in the format of a file FL0 in the storage section 114. In other words, the storage section 114 stores the file FL0. Examples of the file format include a joint photographic experts group (JPEG) format, a bitmap format, and the like. Note that the control section 110 may accept settings including the file format, the resolution of the captured image IMO that is included in the file FL0, and the like via the operation section 115, and store the file FL0 according to the settings in the storage section 114. The captured image IMO being stored in the RAM 113 may serve as a trigger that causes the control section 110 to automatically generate the file FL0 of the captured image IMO and store the file FL0 in the storage section 114.

In present specific example, in order to prevent camera shake or the like due to a button operation for imaging, imaging is automatically performed with satisfaction of the imaging condition as a trigger. However, even if automatic imaging is performed, when there is a time lag between when the user US1 positions the imaging section 120 towards the test pattern TP0 and when the captured image IMO is obtained, there is a possibility that camera shake will occur at the actual imaging time. In this specific example, by confirming that the state without camera shake continues for a certain period of time, the risk of camera shake at the actual imaging time is reduced. As shown in FIG. 14, when the user US1 holds the medium ME0 by hand and holds it in front of the imaging device, there is a risk that the medium ME0 may become distorted. In this specific example, by confirming that the state without distortion of the test pattern TP0 continues for a certain period of time, the possibility of distortion of the test pattern TP0 at the actual imaging time is reduced.

### 3. SPECIFIC EXAMPLE OF IMAGING CONTROL PROCESS

FIG. 5 schematically illustrates an example of the imaging control process performed by the control section 110. Here, steps S102 to S106 correspond to the judgment function FU1, and step S110 corresponds to the imaging control function FU2. Hereinafter, the word “step” may be omitted, and reference numerals of steps may be indicated in parentheses. The imaging control process is started when the control section 110 receives an imaging command for the imaging target region AR0 via the operation section 115. The imaging command may be an operation on an imaging instruction region displayed after the imaging control program PRO is activated, an operation on a shutter button, an activation operation of the imaging control program PRO, or the like. FIGS. 6 to 12 schematically illustrate examples of each condition included in the imaging conditions.

When the imaging control process is started, the control section 110 judges whether a new frame FR0 is transferred from the image sensor 123 to RAM 113 (S102). The judgment process of S102 is repeated until a new frame FR0 is transferred. It can be said that the judgment process of S102 is a process for judging whether a new frame FR0 is acquired from the imaging section 120.

When the new frame FR0 is transferred, the control section 110 acquires condition satisfaction determination information for judging whether an imaging condition for causing the imaging section 120 to execute imaging of the imaging target region AR0 including the test pattern TP0 is satisfied (S104). The condition satisfaction determination information includes the variation V of the relative positional relationship between the imaging section 120 and the medium ME0, and the gap amount D corresponding to the gap between the imaging section 120 and the medium ME0. The details of the condition satisfaction determination information will be described later.

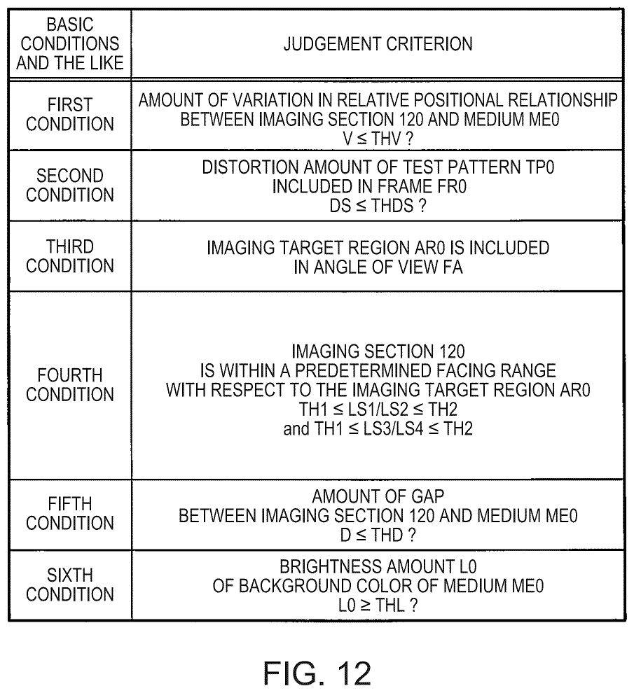

After acquiring the condition satisfaction determination information, the control section 110 judges whether the basic condition for imaging and the like are satisfied based on the frame FR0 and the condition satisfaction determination information (S106). Basic condition means at least one condition of a first condition (shown in FIGS. 6 and 12) and a second condition (shown in FIGS. 7 and 12). The basic condition and the like may include an additional condition. Additional condition means at least one condition of a third condition (shown in FIGS. 8 and 12), a fourth condition (shown in FIGS. 9 and 12), a fifth condition (shown in FIGS. 10 and 12), and a sixth condition (shown in FIGS. 11 and 12). When the basic condition or the like is satisfied, the control section 110 proceeds the processing to S108. When the basic condition or the like is not satisfied, the control section 110 returns the process to S102. When the basic condition or the like includes a plurality of conditions, the control section 110 judges whether all of the plurality of conditions are satisfied, and proceeds the process to S108 when all of the plurality of conditions are satisfied, and returns the process to S102 when any of the plurality of conditions is not satisfied. When the process returns to S102, the control section 110 may output guidance for satisfying the condition that is not satisfied. The output of the guidance may be a display on the display section 116, a voice output to a voice output section (not illustrated), or the like.

As described above, the processing of S102 to S106 is repeated until the basic condition and the like are satisfied, and the control section 110 repeatedly acquires the frame FR0 from the imaging section 120 and repeatedly acquires the condition satisfaction determination information.

FIG. 6 schematically illustrates an example of whether the first condition is satisfied, in which the variation V of the relative positional relationship between the imaging section 120 and the medium ME0 is equal to or less than the threshold THV. The threshold THV is an example of a reference variation, and is a positive value.

The control section 110 repeatedly acquires the frame FR0 from the imaging section 120. Here, the frame FR0 acquired last time is referred to as a “last frame FR1”, and the frame FR0 acquired this time is referred to as a “present frame FR2”. The control section 110 may acquire, as the variation V, the distances by which the feature points included in the last frame FR1 and the present frame FR2 have moved between the last frame FR1 and the present frame FR2. Examples of the feature point include the position detection pattern MK0, a corner of the individual pattern TP1, and the like. When there are a plurality of feature points, the control section 110 may acquire an average value of a plurality of movement distances obtained for each of the plurality of feature points as the variation V. FIG. 6 shows a state in which the movement distances V1, V2, V3, and V4 of the position detection patterns MK0 at four locations are obtained based on the last frame FR1 and the present frame FR2, and the variation V is acquired by averaging the movement distances Vi.

In a case where the information terminal 1 includes a sensor SS1, for example, a speed sensor or an acceleration sensor, the control section 110 may acquire detection values of the sensor SS1, for example, speed values or acceleration values as the variation V. In this case, it is assumed that the medium ME0 is stationary.

The control section 110 can repeatedly acquire the variation V and judge whether the first condition is satisfied based on the acquired variation V. When the variation V is equal to or less than the threshold THV, the control section 110 judges that the first condition is satisfied. When the variation V is larger than the threshold THV, the control section 110 judges that the first condition is not satisfied.

When the first condition is not satisfied, the control section 110 may output guidance for satisfying the first condition. An example of the output of the guidance is displaying information or outputting by voice “Please keep the camera still.”

FIG. 7 schematically illustrates an example of whether the second condition is satisfied, the second condition being that the distortion amount DS indicating the distortion of the test pattern TP0 included in the frame FR0 corresponding to the angle of view FA is equal to or less than the threshold THDS. As shown in the middle section of FIG. 7, the shape of the test pattern TP0 included in the frame FR0 may become a shape distorted from, as shown in the upper section of FIG. 7, the shape of the test pattern TP0 on the medium ME0. The control section 110 can judge whether the second condition is satisfied based on the shape of the test pattern TP0 included in the frame FR0. The threshold THDS is an example of a reference distortion amount, and is a positive value.

When the region of the test pattern TP0 is rectangular and the test pattern TP0 is included in the frame FR0, the control section 110 can calculate the gap between adjacent corners C1 in the rectangular region of the test pattern TP0 included the frame FR0 based on the frame FR0. In FIG. 7, lengths LT1 and LT2 corresponding to the vertical sides and lengths LT3 and LT4 corresponding to the horizontal sides are illustrated. The distortion amount DS for the vertical side can be expressed as a value greater than 1, for example, as LT1/LT2 when LT1>LT2, or as LT2/LT1 when LT1<LT2. The distortion amount DS for the horizontal side can be represented by a value larger than 1, for example, LT3/LT4 in a case where LT3>LT4, and LT4/LT3 in a case where LT3<LT4. Assuming that the threshold THDS is set to a value larger than 1, the control section 110 judges that the second condition is satisfied when the distortion amount DS for the vertical side is equal to or smaller than the threshold THDS and also the distortion amount DS for the horizontal side is equal to or smaller than the threshold THDS. The threshold THDS is not particularly limited, but may be set to 1.2 or the like. When the distortion amount DS for the vertical side is larger than the threshold THDS or the distortion amount DS for the horizontal side is larger than the threshold THDS, the control section 110 judges that the second condition is not satisfied.

Of course, it is also possible to use percentages instead of the length ratios.

The control section 110 may obtain the angles α1, α2, α3, and α4 of the four corner C1 of the quadrangular region of the test pattern TP0 based on the frame FR0. The distortion amount DS at the four corners C1 can be expressed by, for example, differences |α1−90°|, |α2−90°|, |α3−90°|, and |α4−90°| between the angles α1, α2, α3, and α4 and the angle 90°. For example, the control section 110 can judge that the second condition is satisfied when the threshold THDS is a value greater than 0° and less than 45° and the differences |α1−90°|, |α2−90°|, |<3−90°|, and |α4−90°| are all less than or equal to the threshold THDS. The control section 110 can judge that the second condition is not satisfied when at least one of the differences |α1−90°|, |α2−90°|, |α3−90°|, and |α4−90°| is larger than the threshold THDS.

The control section 110 may judge that the second condition is satisfied when both the condition for the lengths LT1 to LT4 and the condition for the angles α1 to α4 are satisfied.

Further, when the frame FR0 includes a rectangular medium ME0, the control section 110 may obtain the angles θ1, θ2, θ3, and θ4 (see FIG. 9) of the four corner C0 of the medium ME0 based on the frame FR0. The distortion amount DS of the four corner C0 can be expressed by, for example, differences |θ1−90°|, |θ2−90°|, |θ3−90°|, and |θ4−90°| between the angles θ1, θ2, θ3, and θ4 and the angle 90°. When both of these differences are equal to or less than the threshold THDS, the control section 110 can judge that the second condition is satisfied. When at least one of the differences |θ1−90°|, |θ2−90°|, |θ3−90°|, and |θ4−90°| is larger than the threshold THDS, the control section 110 can judge that the second condition is not satisfied.

As described above, the control section 110 judges whether the second condition is satisfied based on the shape of the test pattern TP0 included in the frame FR0. When the second condition is not satisfied, the control section 110 may output guidance for satisfying the second condition. An example of the output of the guidance is displaying information or outputting by voice “Aim the camera so that the test pattern is not distorted.”

FIG. 8 schematically illustrates examples of whether the third condition that the imaging target region AR0 is included in the angle of view FA of the imaging section 120 is satisfied. Whether the third condition is satisfied can be judged by judging whether the imaging target region AR0 is completely included in the frame FR0 corresponding to the angle of view FA. When the imaging range is an unintended range, the third condition is not satisfied. When the third condition is satisfied, the imaging range is appropriate.

For example, it is assumed that the medium ME0 has the position detection patterns MK0 at four corners of the imaging target region AR0. In this case, the control section 110 can judge that the third condition is satisfied if the position detection pattern MK0 at four corners can be detected from the frame FR0. The control section 110 can judge that the third condition is not satisfied if even one of the four position detection pattern MK0 from the frame FR0 cannot be detected.

When the medium ME0 does not have the position detection pattern MK0, the medium ME0 itself serves as the imaging target region AR0. When the medium ME0 is rectangular, the control section 110 can detect a plurality of edges from the frame FR0, and if a rectangle surrounded by two edges judged to be vertical and two edges judged to be horizontal can be detected, the third condition can be judged to be Since there is a possibility that the medium ME0 included in the frame FR0 is tilted, “vertical direction” is considered to be a direction that includes a deviation from a strict vertical direction within a range of a predetermined allowable angle, and “horizontal direction” is considered to be a direction that includes a deviation from a strict horizontal direction within a range of a predetermined allowable angle. For recognition of the medium ME0 from frame FR0, rectangle recognition in the related art, such as business card recognition can be applied.

As described above, the control section 110 judges whether the third condition is satisfied based on the frame FR0 repeatedly acquired from the imaging section 120. When the third condition is not satisfied, the control section 110 may output guidance for satisfying the third condition. An example of the output of the guidance is displaying information or outputting by voice “Please place the entire test pattern in the screen.”

FIG. 9 schematically illustrates an example of whether the fourth condition that the imaging target region AR0 of the imaging section 120 is within the predetermined facing range is satisfied. FIG. 9 shows the shape of the imaging target region AR0 included in the frame FR0. The control section 110 can judge whether the fourth condition is satisfied based on the shape of the imaging target region AR0 included in the frame FR0. When the imaging section 120 is not within the facing range with respect to the test pattern TP0, the resolutions are different between the side close to the imaging section 120 and the side far from the imaging section 120 in the test pattern TP0, and the obtained adjustment value may be different between the side close to the imaging section 120 and the side far from the imaging section 120. When the fourth condition is satisfied, a more appropriate test pattern captured image can be used for adjusting the printing characteristics.

As described above, the control section 110 judges whether the imaging target region AR0 is included in the frame FR0. When the imaging target region AR0 has a rectangular shape and the imaging target region AR0 is included in the frame AR0, the control section 110 can obtain the interval between the corner C0 adjacent to each other based on the frame FR0. FIG. 9 illustrates a length LS1 corresponding to the vertical side S1 (refer to FIG. 3), a length LS2 corresponding to the vertical side S2 (refer to FIG. 3), a length LS3 corresponding to the horizontal side S3 (refer to FIG. 3), and a length LS4 corresponding to the horizontal side S4 (refer to FIG. 3). The imaging section 120 being within the predetermined facing range with respect to the imaging target region AR0 means that the difference between the length LS1 of the vertical side S1 and the length LS2 of the vertical side S2 is small and the difference between the length LS3 of the horizontal side S3 and the length LS4 of the horizontal side S4 is small. In order to quantitatively define the facing range, thresholds TH1 and TH2 are applied to the length ratio LS1/LS2 of the vertical side and the length ratio LS3/LS4 of the horizontal side. The threshold TH1 is a positive value smaller than 1, and 0.5<TH1<1 in the example shown in FIG. 9. It can be said that as the threshold TH1 approaches 1, the imaging section 120 more directly faces the imaging target region AR0. The threshold TH2 is larger than 1, and 1<TH2<2 in the example shown in FIG. 9. It can be said that as the threshold TH2 approaches 1, the imaging section 120 more directly faces the imaging target region AR0. In a case where the position is within the facing range, that is, TH1≤LS1/LS2≤TH2 and TH1≤LS3/LS4≤TH2, the control section 110 judges that the fourth condition is satisfied. In a case where LS1/LS2<TH1, LS1/LS2>TH2, LS3/LS4<TH1, or LS3/LS4>TH2, the control section 110 judges that the fourth condition is not satisfied.

Of course, it is also possible to use percentages 100×LS1/LS2 (%) and 100×LS3/LS4 (%) instead of the length ratios LS1/LS2 and LS3/LS4.

The control section 110 may obtain the angles θ1, θ2, θ3, and θ4 of the four corners C0 of the imaging target region AR0 based on the frame FR0. The imaging section 120 being within the predetermined facing range with respect to the imaging target region AR0 means that all of the angles θ1, θ2, θ3, and θ4 are near 90°. In order to quantitatively define the facing range, thresholds TH3, TH4 are applied to the angles θ1, θ2, θ3, and θ4. The threshold TH3 is a positive value smaller than 90°, and in the example shown in FIG. 9, 45°<TH3<90°. It can be said that the closer the threshold TH3 is to 90°, the more directly the imaging section 120 faces the imaging target region AR0. The threshold TH4 is a value larger than 90°, and in the example shown in FIG. 9, 90°<TH4<135°. It can be said that the closer the threshold TH4 is to 90°, the more directly the imaging section 120 faces the imaging target region AR0. When the position is within the facing range, that is, when TH3≤θ1≤TH4, TH3≤θ2≤TH4, TH3≤θ3≤TH4, and TH3≤θ4≤TH4, the control section 110 judges that the fourth condition is satisfied. When θ1<TH3, θ1>TH4, θ2<TH3, θ2>TH4, θ3<TH3, θ3>TH4, θ4<TH3, or θ4>TH4, the control section 110 judges that the fourth condition is not satisfied.

The control section 110 may judge that the fourth condition is satisfied when both the conditions for the length ratios LS1/LS2 and LS3/LS4 and the conditions for the angles θ1 to θ4 are satisfied.

As described above, the control section 110 judges whether the fourth condition is satisfied based on the shape of the imaging target region AR0 included in the frame FR0. When the fourth condition is not satisfied, the control section 110 may output guidance for satisfying the fourth condition. An example of the output of the guidance is displaying information or outputting by voice “Please aim the camera directly at the test pattern.”

FIG. 10 schematically illustrates an example of whether the fifth condition is satisfied, the fifth condition being that the gap amount D corresponding to the gap between the imaging section 120 and the medium ME0 is less than or equal to the threshold THD. The threshold THD is an example of a reference gap amount, and is a positive value. If the imaging section 120 is too far from the medium ME0, the resolution of the imaged test pattern TP0 become low, and errors in the adjustment values become large. When the fifth condition is satisfied, a more appropriate test pattern captured image can be used for adjusting the printing characteristics.

As described above, the control section 110 judges whether the imaging target region AR0 is included in the frame FR0. When the imaging target region AR0 is included in the frame FR0, the control section 110 can obtain the area Sa of the imaging target region AR0 based on the frame FR0. Here, the area of the frame FR0 is denoted by Sf. The area ratio Sa/Sf of the imaging target region AR0 to the frame FR0 increases as the imaging section 120 approaches the medium ME0, and decreases as the imaging section 120 moves away from the medium ME0. Since the maximum value of the area ratio Sa/Sf is 1, the gap amount D can be expressed by 1−(Sa/Sf).

When the information terminal 1 includes a sensor SS2, for example, a distance-measuring sensor, the control section 110 may acquire detection values of the sensor SS2, for example, distances from the imaging section 120 to the medium ME0 as the gap amount D.

The control section 110 can repeatedly detect the gap amount D and judge whether the fifth condition is satisfied based on the detected gap amounts D. When the gap amount D is equal to or less than the threshold THD, the control section 110 judges that the fifth condition is satisfied. When the gap amount D is larger than the threshold THD, the control section 110 judges that the fifth condition is not satisfied. When the gap amount D is extremely close to 0, the third condition (see FIG. 8) will not be satisfied, and thus, it is sufficient to have the threshold THD indicating the upper limit of the gap amount D.

The control section 110 may judge that the fifth condition is satisfied when both the condition based on the area ratio Sa/Sf and the condition based on the detection value of the sensor SS2 are satisfied.

When the fifth condition is not satisfied, the control section 110 may output guidance for satisfying the fifth condition. An example of the output of the guidance is displaying information or outputting by voice “Please bring the camera closer to the test pattern.”

The FIGS. 11A and 11B schematically illustrate an example of whether the sixth condition that the brightness amount L0 indicating the brightness L of the background color of the medium ME0 is equal to or greater than the threshold THL is satisfied. The brightness L may be a brightness value obtained from the pixel values of the frame FR0, for example, a mean value of R (red), G (green), and B (blue) values, or a lightness value obtained from the pixel values of the frame FR0 or the like. The threshold THL is an example of a reference brightness amount, and is a positive value. For example, when the captured image IMO is dark due to the influence of a shadow or the like, the density of the captured test pattern TP0 becomes high, and the color of the like of the test pattern TP0 is not correctly acquired. When the sixth condition is satisfied, a more appropriate test pattern captured image can be used for adjusting the printing characteristics.

In general, the background color of the medium ME0 is brighter than the test pattern TP0. When the pixel number Np is plotted against the brightness L in the frame FR0 obtained from the imaging section 120 facing the medium ME0, a peak P1 of the brightness LP1 corresponding to the background color of the medium ME0 and a peak P2 of the brightness corresponding to the test pattern TP0 appear. The peak P1 is at a position brighter than the peak P2. As shown in FIG. 11A, when the brightness LP1 of the peak P1 is the brightness amount L0, the thresholds for the brightness amount L0 can be set to threshold THL. The threshold THL is a positive value smaller than the upper limit value of the brightness L. When the brightness amount L0 is equal to or greater than the threshold THL, the control section 110 can judge that the sixth condition is satisfied. When the brightness amount L0 is smaller than the threshold THL, the control section 110 can judge that the sixth condition is not satisfied.

Instead of the peak P1 of the brightness LP1, a statistical typical value such as a mean value may be used of the pixel number Np at the brightness L at which the pixel number Np exceeds a predetermined value.

As shown in FIG. 11B, the control section 110 may determine the area St of the graph that is above the positive threshold THS, which is smaller than the upper limit value of brightness L. For example, it may determine the sum of the pixel numbers Np that are above the threshold THS. The area St increases as the background color of the medium ME0 becomes brighter, and decreases as the background color of the medium ME0 becomes darker. Therefore, when the area St is set as the brightness amount L0, the brightness amount L0 can be set to threshold THL. The threshold THL is a positive value smaller than the entire graph area Sh, for example, the pixel numbers of the frame FR0. The area ratio St/Sh above the threshold THS relative to the entire graph increases as the background color of the medium ME0 becomes brighter, and decreases as the background color of the medium ME0 becomes darker. Therefore, when the area ratio St/Sh is set as the brightness amount L0, the threshold with respect to the brightness amount L0 can be set to the threshold THL. The threshold THL is a positive value smaller than 1. Of course, it is also possible to use a percentage 100×St/Sh (%) instead of the area ratio St/Sh.

When the brightness amount L0 is equal to or greater than the threshold THL, the control section 110 can judge that the sixth condition is satisfied. When the brightness amount L0 is smaller than the threshold THL, the control section 110 can judge that the sixth condition is not satisfied.

The judgment of the sixth condition may be performed by a related art method other than the above-described method.

As described above, the control section 110 acquires the brightness amount L0 of the background color of the medium ME0 based on the frame FR0, and judges whether the sixth condition is satisfied based on the acquired brightness amount L0. When the sixth condition is not satisfied, the control section 110 may output guidance for satisfying the sixth condition. An example of the output of the guidance is displaying information or outputting by voice “Please put the test pattern in a bright environment.”

FIG. 12 schematically illustrates an example of criteria for judging the basic condition and the additional condition. Basic condition means at least one condition of the first condition and the second condition. Additional condition means at least one condition of the third condition, the fourth condition, the fifth condition, and the sixth condition. The basic condition and the like may be an AND condition of the six conditions, but as long as at least one condition of the first condition and the second condition is included, the first condition may not be included, the second condition may not be included, the third condition may not be included, the fourth condition may not be included, the fifth condition may not be included, and the sixth condition may not be included. In the printing system SY1 shown in FIG. 1, it is sufficient that the basic condition and the like include at least the first condition. In the printing system SY1 illustrated in FIG. 14, it is sufficient that the basic condition and the like include at least the second condition.

In the judgment process of S106 shown in FIG. 5, when the basic condition or the like is satisfied, the control section 110 starts counting the standby time Tc (S108). When the standby time Tc reaches the predetermined time T0, the imaging condition for causing the imaging section 120 to execute imaging of the imaging target region AR0 is satisfied. The predetermined time T0 of the judgment criterion of the imaging condition including the first condition is not particularly limited, but may be about 1 to 2 seconds when the imaging section 120 does not include the picture blur correction section 124, and may be about 0.5 to 1 second when the imaging section 120 includes the picture blur correction section 124.

Next, the control section 110 causes the display section 116 to display the imaging standby information IN3 indicating that the basic condition and the like are continuously satisfied (S110). The imaging standby information IN3 may be character information for prompting the user to hold still because it is during the time to hold still, or may be numerical information for counting down the remaining time during which the user must continue to hold still. The remaining time is a time obtained by subtracting the standby time Tc from the predetermined time T0. The control section 110 may cause a voice output section (not shown) to output the imaging standby information IN3 by audio. The imaging standby information IN3 is information indicating that at least the basic condition is continuously satisfied. When the basic condition and the like include the additional condition, the imaging standby information IN3 is information indicating that the basic condition and the additional condition are continuously satisfied.

The control section 110 judges whether the predetermined time T0 has elapsed since the basic condition or the like was satisfied in S106, that is, whether the standby time Tc has reached the predetermined time T0 (S112). When the standby time Tc has not reached the predetermined time T0, the control section 110 updates the condition satisfaction determination information including the variation V and the gap amount D (S114), and judges whether the basic condition and the like are satisfied based on the frame FR0 and the condition satisfaction determination information (S116). In a case where a new frame FR0 is transferred from the image sensor 123 to the RAM 113, the control section 110 judges whether the basic condition or the like is satisfied on the basis of the new frame FR0 and the condition satisfaction determination information. When the basic condition or the like is satisfied, the control section 110 returns the process to S110. In this case, the processing from S110 to S116 is repeated until the standby time Tc reaches the predetermined time T0. When the basic condition or the like is not satisfied in S116, the control section 110 returns the process to the first S102. In this case, the standby time Tc is reset, and in order to satisfy the imaging condition, it is necessary to continue satisfying the basic condition and the like for the predetermined time T0.

When the standby time Tc reaches the predetermined time T0, the imaging condition is satisfied, and thus the control section 110 acquires the captured image IMO by causing the imaging section 120 to perform imaging of the imaging target region AR0 (S118). At this time, the CPU 111 may store the captured image IMO from the image sensor 123 in the RAM 113, or the DMA controller may store the captured image IMO from the image sensor 123 in the RAM 113. The captured image IMO has a higher resolution than frame FR0.

As described above, the control section 110 acquires the captured image IMO by causing the imaging section 120 to execute imaging of the imaging target region AR0 with satisfaction of the imaging condition as a trigger. The imaging condition is a condition that at least one basic condition of the first condition and the second condition a is satisfied for predetermined time T0 or more. The control section 110 judges that the imaging condition is satisfied when at least the basic condition is continuously satisfied for a predetermined time T0 or more. When the basic condition and the like include at least one additional condition of the third condition, the fourth condition, the fifth condition, and the sixth condition, the imaging condition is a condition that the basic condition and the additional condition are continuously satisfied for the predetermined time T0 or more. The control section 110 judges that the imaging condition is satisfied when the basic condition and the additional condition are continuously satisfied for a predetermined time T0 or more.

After the captured image IMO is acquired, the control section 110 judges whether to store the captured image IMO as file FL0 (S120). For example, when the operation section 115 receives an operation of storing the captured image IMO, the control section 110 stores the captured image IMO in the format of file FL0 in the storage section 114 (S122) and ends the imaging control process. In other words, the storage section 114 stores the file FL0. When the operation section 115 receives an operation to discard the captured image IMO, the control section 110 ends the imaging control process without performing the saving process on S122.

In addition, in S120, the control section 110 may judge whether the test pattern TP0 included in the captured image IMO is appropriate for adjusting the printing characteristics. In this case, the control section 110 may perform a saving process as S122 when it is judged to be appropriate or may return the process to S102 when it is judged to be inappropriate. By performing the process in S122 without performing the judgment process in S120, the control section 110 may automatically generate the file FL0 of the captured image IMO and store it in the storage section 114 by using the storage of the captured image IMO in the RAM 113 as a trigger.

In the printing system SY1 illustrated in FIG. 1, the first condition in which the variation V (shown in FIGS. 6 and 12) is equal to or less than the threshold THV is included in the basic condition or the like, and thus the imaging condition is satisfied after a state in which the picture blur of the imaging section 120 is small continues for the predetermined time T0. By this, even if there is a time lag from when the user is in the posture for imaging until the captured image IMO of the test pattern TP0 is actually acquired, the picture blur is likely to remain small even at the time point when the time lag has elapsed since the state in which the picture blur is small continues. Since the picture blur of the test pattern TP0 included in the captured image IMO is small, it is possible to use an appropriate test pattern TP0 for adjusting the printing characteristics.

In the printing system SY1 illustrated in FIG. 14, the second condition in which the distortion amount DS (shown in FIGS. 7 and 12) is equal to or less than the threshold THDS is included in the basic condition and the like, and thus the imaging condition is satisfied after a state in which distortion such as bending of the medium ME0 having the test pattern TP0 is small continues for a predetermined time T0. By this, even if the user US1 holds the medium ME0 by hand and holds it in front of the imaging device, the distortion of the test pattern TP0 is likely to be small at the time of imaging because the state in which the distortion of the medium ME0 is small continues. Since the distortion of the test pattern TP0 included in the captured image IMO is small, an appropriate test pattern captured image can be used for adjusting the printing characteristics.

In the printing system SY1 (shown in FIGS. 1 and 14), the third condition that the imaging target region AR0 is included in the angle of view FA of the imaging section 120 (as shown in FIGS. 8 and 12) is the additional condition, and thus the imaging condition is satisfied after the state in which the imaging target region AR0 is included in the angle of view FA continues for the predetermined time T0. By this, there is a high possibility that the imaging target region AR0 is included in the captured image IMO at the time of imaging. As illustrated in FIGS. 9 and 12, when the fourth condition that the imaging section 120 is within a predetermined facing range with respect to the imaging target region AR0 is included in the additional conditions, the imaging condition is satisfied after the facing state continues for the predetermined time T0. By this, there is a high possibility that the captured image IMO is generated in a state where the imaging section 120 is within the predetermined facing range with respect to the imaging target region AR0 at the time of imaging. When the additional condition includes the fifth condition that the gap amount D is equal to or less than the threshold THD (as shown in FIGS. 10 and 12), the imaging condition is satisfied after the state in which the imaging section 120 is not too far from the medium ME0 continues for the predetermined time T0. By this, it increases the possibility of generating the captured image IMO in a state where the imaging section 120 is not too far from the medium ME0 at the time of imaging. By having the sixth condition, in which the brightness amount L0 (shown in FIGS. 11 and 12) is above the threshold THL, as an additional condition, the imaging conditions are met after the test pattern TP0 remains in a state that is not too dark for a predetermined time T0. By this, there is a high possibility that the captured image IMO in which the test pattern TP0 is not too dark at the time of imaging is generated.

As described above, in the present specific example, it is possible to acquire the imaging result of the test pattern TP0 that has high reliability. By this, it is possible to use an appropriate test pattern captured image for adjusting the printing characteristics, and it is possible to suppress the memory from being burdened by an unnecessary captured image.

The control section 110 can acquire an adjustment value for adjusting the printing characteristics of the printing device 2 based on the pixel value of the test pattern TP0 included in the captured image IMO. When the test pattern TP0 is a density pattern for adjusting the density of the print image PIO, the control section 110 can acquire a density adjustment value for adjusting the density of the print image PIO based on the pixel value of the test pattern TP0. When the test pattern TP0 is a Bi-d adjustment pattern for Bi-d adjustment, the control section 110 can acquire a Bi-d adjustment value for performing Bi-d adjustment based on the pixel value of the test pattern TP0. When the test pattern TP0 is a transport amount adjustment pattern for adjusting the transport amount of the medium ME0, the control section 110 can acquire a transport amount adjustment value for adjusting the transport amount of the medium ME0 based on the pixel value of the test pattern TP0.

FIG. 13 schematically illustrates an example of adjustment of printing characteristics.

Density adjustment means setting of an adjustment value A1 for adjusting the density of the print image PIO to the density of the inputted image. For example, as shown in FIG. 13, it is assumed that the print image PIO is darker than the inputted image. In this case, the output density of an individual pattern TP1 is higher than the density of individual pattern data DA1 for forming the individual pattern TP1. The control section 110 can cause the printing device 2 to execute density adjustment by setting, in the controller 210 of the printing device 2, adjustment value A1 corresponding to deviations in output density of the individual pattern data DA1 from the density of the individual pattern TP1. The controller 210 can adjust the density of the print image PIO to the density of the inputted image by decreasing the output density of the individual pattern TP1 corresponding to the individual pattern data DA1 to the density of the individual pattern DA1 in accordance with the adjustment value A1. Of course, even when the printing density of the print image PIO is lighter than the inputted image, the density of the print image PIO can be matched to the density of the inputted image by setting the adjustment value A1.

Bi-d adjustment means setting of an adjustment value A2 for matching the landing position of the droplet 280 of the forward pass and the landing position of the droplet 280 of the return pass in the main scanning direction D1 in a case where the printing device 2 repeats the main scanning and the sub-scanning at the time of printing. Here, the forward pass means main scanning in which the recording head 220 moves in the forward direction D11, and the return pass means main scanning in which the recording head 220 moves in the return direction D12. For example, as shown in FIG. 13, it is assumed that the landing position of the return pass to be aligned with the landing position of the forward pass in the main scanning direction D1 is shifted in the forward direction D11 from the landing position of the forward pass. In this case, the position of the individual pattern TP1 formed on the medium ME0 in the return pass is shifted in the forward direction D11 from the position of the individual pattern TP1 formed on the medium ME0 in the forward pass. The control section 110 can, for example, cause the printing device 2 to execute Bi-d adjustment by setting the adjustment value A2 corresponding to the positional deviation of the individual patterns TP1 in the controller 210 of the printing device 2. The controller 210 delays the timing of ejecting the droplets 280 from the recording head 220 in the return pass in accordance with the adjustment value A2, and thus the landing positions of the droplets 280 in the main scanning direction D1 can be matched between the forward pass and the return pass. Of course, even when the landing position of the return pass to be aligned with the landing position of the forward pass in the main scanning direction D1 is shifted in the return direction D12 from the landing position of the forward pass, the landing positions of the droplets 280 in the main scanning direction D1 can be aligned between the forward pass and the return pass by setting the adjustment value A2.

PF adjustment as the transport amount adjustment means setting an adjustment value A3 for adjusting the transport amount of the medium ME0 at the time of the sub-scanning in the sub-scanning direction D2 without excess or deficiency. Sub-scanning direction D2 means the direction in which the recording head 220 moves relative to the medium ME0, and the transport direction in which the medium ME0 moves relative to the recording head 220 is the opposite direction from the sub-scanning direction D2. If the transport amount of the medium ME0 during sub-scanning is too large, a streak in which a gap is generated between band regions, for example, a light streak, is generated, and if the transport amount of the medium ME0 during the sub-scanning is too small, a streak in which dots overlap each other between band regions, for example, a dark streak, is generated. For example, as shown in FIG. 13, the interval between the landing positions of the droplets 280 in the sub-scanning direction D2 between sub-scannings is wider than the band region width WB. In this case, the interval between the individual pattern TP1 formed on the medium ME0 in a certain pass and the individual pattern TP1 formed on the medium ME0 in the previous pass is wider than the band region width WB. The control section 110 can, for example, cause the printing device 2 to execute PF adjustment by setting, in the controller 210 of the printing device 2, an adjustment value A3 corresponding to the shift of the interval between the individual patterns TP1 with respect to the band region width WB. The controller 210 can adjust the transport amount of the medium ME0 during the sub-scanning in the sub-scanning direction D2 without excess or deficiency by reducing the transport amount of the medium ME0 during the sub-scanning according to the adjustment value A3. Of course, even when the interval between the landing positions of the droplets 280 in the sub-scanning direction D2 between sub-scannings is narrower than the design value of the band region width WB, the transport amount of the medium ME0 at the time of sub-scanning can be adjusted to be without excess or deficiency by setting the adjustment value A3.

As described above, the user US1 can easily adjust various printing characteristics by imaging the test pattern TP0 with the information terminal 1.

### 4. MODIFICATIONS

Various modifications can be made to the present disclosure.

For example, the order of the processes described above can be changed as appropriate. For example, in the imaging control process shown in FIG. 5, the process of S104 that acquires the condition satisfaction determination information can be performed before the process of S102.

As illustrated in FIG. 15, the predetermined time T0 of the judgment criterion of the imaging condition may be changed according to the presence or absence of the picture blur correction function in the information terminal 1. FIG. 15 schematically illustrates an example of the judgment standby time determination process performed according to the imaging control program PRO. The judgment standby time determination process is a process for determining the predetermined time T0 as the judgment standby time, is performed by the control section 110 before the imaging control process illustrated in FIG. 5, and corresponds to the judgment function FU1 that the imaging control program PRO causes the information terminal 1 to realize.

When the judgment standby time determination processing is started, the control section 110 acquires the picture blur correction correspondence information IN1 indicating whether the imaging section 120 includes the picture blur correction section 124 (S202). The imaging control program PRO as an application program causes the information terminal 1 to acquire the picture blur correction correspondence information IN1 from the OS by requesting the OS to output the picture blur correction correspondence information IN1. The control section 110 that executes the imaging control program PRO may receive a selection operation of whether there is a blur correction function from the user US1 via the operation section 115. In addition, the control section 110 may acquire the picture blur correction correspondence information IN1 indicating that the blur correction function is present when the blur correction function is selected, and may acquire the picture blur correction correspondence information IN1 indicating that the blur correction function is absent when the blur correction function is not selected. Further, the control section 110 may display a “long standby time mode” and a “short standby time mode” in the selection field of the display section 116, acquire the picture blur correction correspondence information IN1 indicating that the blur correction function is present in a case where the “long standby time mode” is selected, and acquire the picture blur correction correspondence information IN1 indicating that the blur correction function is not present in a case where the “short standby time mode” is selected.

After acquiring the picture blur correction correspondence information IN1, the control section 110 judges whether the imaging section 120 has the blur correction function, that is, whether the picture blur correction correspondence information IN1 indicates that the blur correction function is present, on the basis of the picture blur correction correspondence information IN1 (S204). When the picture blur correction correspondence information IN1 indicates that the blur correction function is not provided, the control section 110 sets the predetermined time T0 as the judgment standby time to the predetermined time T1 (S206), and ends the judgment standby time determination process. The control section 110 applies the predetermined time T1 as the predetermined time T0 in the imaging control process illustrated in FIG. 5. When the picture blur correction correspondence information IN1 indicates that the blur correction function is present, the control section 110 sets the predetermined time T0 as the judgment standby time to a predetermined time T2 shorter than the predetermined time T1 (S208), and ends the judgment standby time determination processing. The control section 110 applies the predetermined time T2 as the predetermined time T0 in the imaging control process illustrated in FIG. 5.

As described above, the judgment function FU1 sets the predetermined time T0 as the judgment standby time to be shorter when the blur correction function is provided than when the blur correction function is not provided, based on the picture blur correction correspondence information IN1.

In a case where the imaging section 120 has a blur correction function, even if a picture blur occurs due to a relatively short time period during which the basic condition or the like is satisfied, the picture blur is corrected. By this, even if the predetermined time T0 is shortened when the imaging section 120 has the blur correction function, it is possible to acquire the image capture result of the test pattern TP0 with high reliability, and to improve usability.

As illustrated in FIG. 16, the predetermined time T0 of the judgment criterion of the imaging condition may be changed according to the exposure time. FIG. 16 schematically illustrates another example of the judgment standby time determination process performed according to the imaging control program PRO. The judgment standby time determination process is also a process for determining the predetermined time T0 as the judgment standby time, is performed by the control section 110 before the imaging control process illustrated in FIG. 5, and corresponds to the judgment function FU1 that the imaging control program PRO causes the information terminal 1 to realize.

When the judgment standby time determination process is started, the control section 110 acquires the exposure time information IN2 from the storage section 114 (S302). The imaging control program PRO as an application program causes the information terminal 1 to acquire the exposure time information IN2 from the OS by requesting the OS to output the exposure time information IN2.

After acquiring the exposure time information IN2, the control section 110 sets a predetermined time T0 as a judgment standby time based on the exposure time information IN2 (S304), and ends the judgment standby time determination process. As illustrated in FIG. 16, it is assumed that the exposure time as the first time TE1 (seconds) is associated with the predetermined time T3 (seconds), and the exposure time as the second time TE2 (seconds) is associated with the predetermined time T4 (seconds). Here, TE2<TE1, and T4<T3. In a case where the exposure time indicated by the exposure time information IN2 is TE1 seconds, the control section 110 sets the predetermined time T0 as the judgment standby time to the predetermined time T3, and applies the predetermined time T0 as the predetermined time T3 in the imaging control process illustrated in FIG. 5. In a case where the exposure time indicated by the exposure time information IN2 is TE2 seconds, the control section 110 sets the predetermined time T0 as the judgment standby time to the predetermined time T4, and applies the predetermined time T4 as the predetermined time T0 in the imaging control process illustrated in FIG. 5.

In this way, based on the exposure time information IN2, the judgment function FU1 shortens the predetermined time T0 as the judgment standby time when the exposure time is the second time (TE2), which is shorter than the first time (TE1).

In a case where the exposure time is relatively short, even if picture blur occurs due to the basic condition or the like being satisfied continuously for a relatively short time, the influence of the picture blur on the captured image IMO is small. By this, even if the predetermined time T0 is shortened when the exposure time is relatively short, it is possible to acquire the imaging result of the test pattern TP0 with high reliability, and to improve usability.

In the process of S304, the predetermined time T0 may be changed depending on whether the imaging section 120 has a blur correction function. For example, the control section 110 may acquire the picture blur correction correspondence information IN1, and when the exposure time is the first time (TE1), the control section 110 may set the predetermined time T3 to be shorter in a case where the blur correction function is present than in a case where the blur correction function is not present based on the picture blur correction correspondence information IN1. In a case where the exposure time is the second time (TE2), the control section 110 may shorten the predetermined time T4 in a case where the blur correction function is present based on the picture blur correction correspondence information IN1, compared to a case where the blur correction function is not present.

As illustrated in FIG. 17, the criterion for condition determination may be changed during the period of the predetermined time T0 illustrated in FIG. 5. FIG. 17 schematically illustrates an example of a process of changing the criterion for condition determination during the period of the judgment standby time. This process corresponds to the judgment function FU1.

The predetermined time T0 shown in FIG. 17 includes the first period PT1 from the beginning to an intermediate time, and the second period PT2 from an intermediate time to the end. Therefore, it can be said that the predetermined time T0 includes a first period PT1 and a second period PT2 after the first period PT1.

After the imaging control process illustrated in FIG. 5 is started and the process of S108 for starting the counting of the standby time Tc is performed, the thresholds illustrated in FIG. 17 are used in the process of S116 for judging whether the basic condition and the like are satisfied.

When the control section 110 judges whether the first condition that the variation V (shown in FIGS. 6 and 12) is equal to or less than the threshold THV is satisfied, it uses the threshold THV1 if the standby time Tc is in the first period PT1, and uses the threshold THV2 if the standby time Tc is in the second period PT2. Here, the threshold THV2 is smaller than the threshold THV1. Therefore, the control section 110 sets the threshold THV2, which is the reference variation applied in the second period PT2, to be smaller than the threshold THV1, which is the reference variation applied in the first period PT1.

When the user US1 aims the imaging section 120 towards the test pattern TP0 for imaging, camera shake often gradually decreases. By this, it can be said that even if camera shake is relatively large at the start time of the standby time Tc, it is known that the user US1 starts to suppress camera shake. In the end, it is sufficient if camera shake is reduced. In the predetermined time T0 as the judgment standby time, if the threshold THV is relatively small in the relatively later second period PT2, even if the threshold THV is relatively large in the relatively earlier first period PT1, a highly reliable imaging result of the test pattern TP0 is obtained. Therefore, the time required for imaging can be shortened.

When the control section 110 judges whether the second condition, which is that the distortion amount DS (shown in FIGS. 7 and 12) is equal to or less than the threshold THDS, is satisfied, it uses the threshold THDS1 if the standby time Tc is in the first period PT1, and uses the threshold THDS2 if the standby time Tc is in the second period PT2. Here, the threshold THDS2 is smaller than the threshold THDS1. Therefore, the control section 110 sets the threshold THDS2, which is the reference variation applied to the second period PT2, to be smaller than the threshold THDS1, which is the reference variation applied to the first period PT1.

When the user US1 holds the medium ME0 by hand and holds it in front of the imaging section 120 for imaging, the distortion of the medium ME0 often becomes smaller. By this, it can be said that even if the distortion of the test pattern TP0 is relatively large at the start of the standby time Tc, it is known that the user US1 starts to suppress the distortion of the medium ME0, and in the end it is only necessary to reduce the distortion of the test pattern TP0. If the threshold THDS is relatively small in the latter second period PT2 within the predetermined time T0 as the judgment standby time, reliable imaging results of the test pattern TP0 can be obtained even if the threshold THDS is relatively large in the earlier first period PT1. Therefore, the time required for imaging can be shortened.

The above-described Aspect 1 includes the following aspects 1A and 1B. In any aspect, it is possible to provide an imaging control program capable of acquiring an imaging result of a test pattern with high reliability.

### Aspect 1A

An imaging control program PRO for imaging a medium ME0 that has a test pattern TP0 for adjusting a printing characteristic of a printing device 2 equipped with the recording head 220, the imaging control program causing a computer to execute:
a judgment function FU1 that judges whether an imaging condition for causing the imaging section 120 to image an imaging target region AR0 including the test pattern TP0 is satisfied;
an imaging control function FU2 that acquires a captured image IMO by causing the imaging section 120 to execute imaging of the imaging target region AR0 with the satisfaction of the imaging condition as a trigger; wherein
the imaging condition is condition that the first condition, where the variation V of the relative positional relationship between the imaging section 120 and the medium ME0 is equal to or less than the reference variation (THV), is satisfied for at least the predetermined time T0,
the judgment function FU1 includes
   repeatedly acquiring the variation V and judging whether the first condition is satisfied based on the acquired variation V,
   judging that the imaging condition is satisfied when at least the first condition is continuously satisfied for the predetermined time T0 or more.

### Aspect 1B

An imaging control program PRO for imaging a medium ME0 that has a test pattern TP0 for adjusting a printing characteristic of the printing device 2 equipped with a recording head 220, the imaging control program causing a computer to execute:
a. judgment function FU1 that judges whether an imaging condition for causing the imaging section 120 to image an imaging target region AR0 including the test pattern TP0 is satisfied;
an imaging control function FU2 that acquires a captured image IMO by causing the imaging section 120 to execute imaging of the imaging target region AR0 with the satisfaction of the imaging condition as a trigger; wherein
the imaging condition is condition that the second condition in which a distortion amount DS indicating the distortion of the test pattern TP0 included in the frame FR0 repeatedly acquired from the imaging section 120 is equal to or less than the reference distortion amount (THDS), is satisfied for at least the predetermined time T0,
the judgment function FU1 includes
   judging whether the second condition is satisfied based on a shape of the test pattern TP0 included in the frame FR0;
   judges that the imaging condition is satisfied when at least the second condition is continuously satisfied for the predetermined time T0 or longer.

A printing system SY1 corresponding to the above-described aspect 1A can also be implemented, and a printing system SY1 corresponding to the above-described aspect 1B can also be implemented. In either case, it is possible to provide a printing system capable of acquiring an imaging result of a test pattern with high reliability.

### 5. CONCLUSIONS

As described above, according to the present disclosure, it is possible to provide a configuration and the like capable of acquiring an imaging result of a test pattern with high reliability by various aspects. As a matter of course, the above-described basic operational effects can be obtained even in an aspect including only the constituent features according to the independent claims.

A configuration in which the respective configurations disclosed in the above-mentioned examples are replaced with each other or combinations thereof are changed, a configuration in which the respective configurations disclosed in the publicly known art and the above-mentioned examples are replaced with each other or combinations thereof are changed, and the like can be implemented. The present disclosure includes these configurations and the like.

What is claimed is:

1. A non-transitory computer readable storage medium storing an imaging control program for imaging a medium having a test pattern for adjusting printing characteristics of a printing device including a recording head, the imaging control program comprising:
causing a computer to execute a judgment function of determining whether an imaging condition for causing an imaging section to execute imaging of an imaging target region including the test pattern is satisfied and
with the satisfaction of the imaging condition as a trigger, causing the computer to execute an imaging control function of causing the imaging section to execute imaging of the imaging target region to acquire a captured image, wherein
the imaging condition is a condition that at least one basic condition is continuously satisfied for a predetermined time or more, the at least one basic condition being at least one of a first condition that a variation amount of a relative positional relationship between the imaging section and the medium is equal to or less than a reference variation or a second condition that a distortion amount indicating distortion of the test pattern included in a frame repeatedly acquired from the imaging section is equal to or less than a reference distortion amount and
the judgment function includes
when judging whether the first condition is satisfied, acquiring repeatedly the change amount and judging whether the first condition is satisfied based on the acquired change amount,
when judging whether the second condition is satisfied, judging whether the second condition is satisfied based on a shape of the test pattern included in the frame, and
when at least the basic condition is continuously satisfied for the predetermined time or more, judging that the imaging condition is satisfied.

2. The non-transitory computer readable storage medium storing the imaging control program according to claim 1, wherein
the imaging condition is a condition that the basic condition and an additional condition are continuously satisfied for the predetermined time or longer,
the additional condition is at least one of a third condition that the imaging target region is included in an angle of view of the imaging section, a fourth condition that the imaging section is within a predetermined facing range with respect to the imaging target region, a fifth condition that a gap amount corresponding to a gap between the imaging section and the medium is equal to or less than a reference gap amount, and a sixth condition that a brightness amount indicating brightness of a background color of the medium is equal to or greater than a reference brightness amount, and
the judgment function includes
when judging whether the third condition is satisfied, judging whether the third condition is satisfied based on the frame,
when judging whether the fourth condition is satisfied, judging whether the fourth condition is satisfied based on a shape of the imaging target region included in the frame,
when judging whether the fifth condition is satisfied, detecting repeatedly the gap amount and judging whether the fifth condition is satisfied based on the detected gap amount,
when judging whether the sixth condition is satisfied, the brightness amount is acquired based on the frame, and judging whether the sixth condition is satisfied based on the acquired brightness amount, and
when at least the basic condition and the additional condition are continuously satisfied for the predetermined time or more, judging that the imaging condition is satisfied.

3. The non-transitory computer readable storage medium storing the imaging control program according to claim 1, wherein
the judgment function is configured to
change the predetermined time and
acquire blur correction correspondence information indicating whether a picture blur correction function for correcting picture blur of the captured image is present and, based on the picture blur correction correspondence information, set the predetermined time shorter when the picture blur correction function is present than when the picture blur correction function is not present.

4. The non-transitory computer readable storage medium storing the imaging control program according to claim 1, wherein
an exposure time applied to the imaging section is changeable and
the judgment function is configured to
change the predetermined time and
acquire exposure time information indicating the exposure time from a control section that controls the imaging section and, based on the exposure time information, set the predetermined time shorter when the exposure time is the second time than when the exposure time is the first time.

5. The non-transitory computer readable storage medium storing the imaging control program according to claim 1, wherein
the judgment function causes an output section to output information indicating that at least the basic condition is continuously satisfied.

6. The non-transitory computer readable storage medium storing the imaging control program according to claim 1, wherein
the predetermined time includes a first period and a second period after the first period and
the judgment function is configured to
when judging whether the first condition is satisfied, set the reference variation applied in the second period to be smaller than the reference variation applied in the first period and
when judging whether the second condition is satisfied, set the reference distortion amount applied in the second period to be smaller than the reference distortion amount applied in the first period.

7. A printing system comprising:
a printing device including a recording head and
an information terminal that captures an image of a medium having a test pattern for adjusting a printing characteristic of the printing device, wherein
the information terminal includes
an imaging section and
a control section that includes a memory for storing a captured image obtained from the imaging section and that causes the imaging section to execute imaging of an imaging target region including the test pattern,
the control section judges whether an imaging condition for causing the imaging section to perform imaging of the imaging target region is satisfied and, with the satisfaction of the imaging condition as a trigger, causes the imaging section to perform imaging of the imaging target region to acquire the captured image,
the imaging condition is a condition that at least one basic condition is continuously satisfied for a predetermined time or more, the at least one basic condition being at least one of a first condition that a variation amount of a relative positional relationship between the imaging section and the medium is equal to or less than a reference variation or a second condition that a distortion amount indicating distortion of the test pattern included in a frame repeatedly acquired from the imaging section is equal to or less than a reference distortion amount, and
the control section executes
when judging whether the first condition is satisfied, acquiring repeatedly the change amount and judging whether the first condition is satisfied based on the acquired change amount,
when judging whether the second condition is satisfied, judging whether the second condition is satisfied based on a shape of the test pattern included in the frame, and
when at least the basic condition is continuously satisfied for the predetermined time or more, judging that the imaging condition is satisfied.
